(19) United States
(12) Patent Application Publication
(10) Pub. No.: US 2005/0256742 A1
(43) Pub. Date: Nov. 17, 2005

(54) Data encryption applications for multi-source longitudinal patient-level data integration

(76) Inventors: Mark E. Kohan, Downingtown, PA (US); Clinton J. Wolfe, Malvern, PA (US)

Correspondence Address: BAKER & BOTTS, 30 ROCKEFELLER PLAZA, NEW YORK, NY, 10112, US

(21) Appl. No.: 11/122,581

(22) Filed: May 5, 2005

Related U.S. Application Data
(60) Provisional application No. 60/568,455, filed on May 5, 2004.
(60) Provisional application No. 60/572,161, filed on May 17, 2004.
(60) Provisional application No. 60/571,962, filed on May 17, 2004.
(60) Provisional application No. 60/572,064, filed on May 17, 2004.
(60) Provisional application No. 60/572,264, filed on May 17, 2004.

(51) Int. Cl. G06F 17/60

(52) U.S. Cl. 705/2

(57) ABSTRACT

Software applications are provided for integrating individual multi-sourced patient healthcare transaction data records in a longitudinal database. The data records are processed in a manner which preserves patient privacy by encrypting patient-identifying attributes in the data records and thereby rendering sensitive personal information inaccessible. The applications, which may be organized as modules using common frame work components, are designed to process the multi-sourced data records at data supplier sites and at a common database assembly facility. The applications provide the data supplier sites and the database facility with methods for acquiring attributes, standardizing formats, encryption key generation, and encrypting and decrypting attributes in the data records. The encryption application provides methods for double encryption of the data records at data supplier sites using a key specific to a data supplier and a key specific to the database facility.

### CROSS REFERENCE TO RELATED APPLICATIONS

This application claims the benefit of U.S. provisional patent application Ser. No. 60/568,455 filed May 5, 2004, U.S. provisional patent application Ser. No. 60/572,161 filed May 17, 2004, U.S. provisional patent application Ser. No. 60/571,962 filed May 17, 2004, U.S. provisional patent application Ser. No. 60/572,064 filed May 17, 2004, and U.S. provisional patent application Ser. No. 60/572,264 filed May 17, 2004, all of which applications are hereby incorporated by reference in their entireties herein.

### BACKGROUND OF THE INVENTION

The present invention relates to the management of personal health information or data on individuals. The invention in particular relates to the assembly and use of such data in a longitudinal database in a manner which maintains individual privacy.

Electronic databases of patient health records are useful for both commercial and non-commercial purposes. Longitudinal (lifetime) patient record databases are used, for example, in epidemiological or other population-based research studies for analysis of time-trends, causality, or incidence of health events in a population. The patient records assembled in a longitudinal database are likely to be collected from a number of sources and in a variety of formats. An obvious source of patient health records is the modern health insurance industry, which relies extensively on electronically communicated patient transaction records for administering insurance payments to medical service providers. The medical service providers (e.g., pharmacies, hospitals or clinics) or their agents (e.g., data clearinghouses, processors or vendors) supply individually identified patient transaction records to the insurance industry for compensation. The patient transaction records, in addition to personal information data fields or attributes, may contain other information concerning, for example, diagnosis, prescriptions, treatment or outcome. Such information acquired from multiple sources can be valuable for longitudinal studies. However, to preserve individual privacy, it is important that the patient records integrated into a longitudinal database facility are “anonymized” or “de-identified”.

A data supplier or source can remove or encrypt personal information data fields or attributes (e.g., name, social security number, home address, zip code, etc.) in a patient transaction record before transmission to preserve patient privacy. The encryption or standardization of certain personal information data fields to preserve patient privacy is now mandated by statute and government regulation. Concern for the civil rights of individuals has led to government regulation of the collection and use of personal health data for electronic transactions. For example, regulations issued under the Health Insurance Portability and Accountability Act of 1996 (HIPAA), involve elaborate rules to safeguard the security and confidentiality of personal health information. The HIPAA regulations cover entities such as health plans, health care clearinghouses, and those health care providers who conduct certain financial and administrative transactions (e.g., enrollment, billing and eligibility verification) electronically. (See e.g., http://www.hhs.gov/ocr/hipaa). Commonly invented and co-assigned patent application Ser. No. 10/892,021, “Data Privacy Management Systems and Methods”, filed Jul. 15, 2004 (Attorney Docket No. AP35879), which is hereby incorporated by reference in its entirety herein, describes systems and methods of collecting and using personal health information in standardized format to comply with government mandated HIPAA regulations or other sets of privacy rules.

For further minimization of the risk of breach of patient privacy, it may be desirable to strip or remove all patient identification information from patient records that are used to construct a longitudinal database. However, stripping data records of patient identification information to completely “anonymize” them can be incompatible with the construction of the longitudinal database in which the stored data records or fields must be updated individually on a patient by patient basis.

Co-invented and co-assigned patent application Ser. No.______, filed on even date, (Atty. Docket No. AP36247), which is hereby incorporated by reference in its entirety herein, discloses a system which allows patient data records acquired from multiple sources to be integrated patient by patient (i.e. individual by individual) into a longitudinal database without creating any risk of breaching of patient privacy.

The system disclosed in referenced patent application Ser. No. uses a two-step encryption procedure using multiple encryption keys. The system encompasses the data sources or suppliers (“DS”), the longitudinal database facility (“LDF”), and a third-party implementation partner (“IP”). The IP, who may also serve as an encryption key administrator, can operate at a facility component site. At data supplier sites, each DS encrypts selected data fields (e.g., patient-identifying attributes and/or other standard attribute data fields) in the patient records to convert the patient records into a first “anonymized” format. Each DS uses two keys (i.e., a vendor-specific key and a common longitudinal key associated with a specific LDF) to doubly encrypt the selected data fields. The doubly encrypted data records are transmitted to a facility component site, where the IP can process them further. The data records are processed into a second anonymized format, which is designed to allow the data records to be linked individual patient by patient without recovering the original unencrypted patient identification information. For this purpose, the doubly encrypted data fields in the patient records received from a DS are partially de-crypted using the specific vendor key (such that the doubly encrypted data fields still retain the common longitudinal key encryption). A third key (e.g., a token based key) may be used to further prepare the now-singly (common longitudinal key) encrypted data fields or attributes for use in a longitudinal database. Longitudinal identifiers (IDs) or dummy labels that are internal to the longitudinal database facility may be used to tag the data records so that they can be matched and linked individual ID by ID in the longitudinal database without knowledge of original unencrypted patient identification information.

Further consideration is now being given to the design of a double-encryption/matching solution for assembling multi-sourced data records into a longitudinal database. In particular, attention is paid to the design of specific encryption applications. Desirable encryption applications are those that can be integrated with other data processing software applications, and which enable data processing in formats which conform to private initiative standards for preserving patient privacy.

### SUMMARY OF THE INVENTION

The present invention provides software applications for encrypting multi-sourced patient data records to overcome data source variances in individual encryption techniques and in the content of data records. The software applications allow de-identified data records received from multiple data sources or suppliers to be assembled in a longitudinal database for market research and other analysis. The software applications are designed to implement processes that ensure patient privacy consistent with industry and other regulations concerning patient privacy.

The software applications, which are provided on computer-readable media, may be utilized in database assembly processes encompassing multiple data supplier sites and a common longitudinal database facility. The data processing steps include steps for standardizing data, reformatting or acquiring data attributes, and generating audit counts or audit reports in addition to the steps for encryption/decryption of select data and secure management of the encryption at different stages or locations of the data processing.

In an embodiment of the invention, a computer-readable medium for preparing individual patient healthcare transaction data records is organized as a modular collection of methods or functions. The computer-readable medium may, for example, include an acquire attributes module, a standardization module, an encryption key generation module, and an encryption module. Data processing applications installed at a data supplier site or at the longitudinal database facility can call individual methods in these modules for data processing.

The acquire attributes module may include methods for retrieving or getting data attributes from data files to calling applications. The standardization module may include methods for standardization of the data attributes (e.g., Patient Date of Birth; Patient Gender; Cardholder ID; Record Number; Patient Zip Code; Patient First Name; Patient Last Name; Data Supplier Patient ID; and Patient Street Address).

The encryption key generation module includes methods for generating data attribute encryption keys and further includes methods for encrypting the data attribute encryption keys themselves for secure storage or transmission. The data attribute encryption keys include a Data Supplier Longitudinal Encryption Key (Ki) specific to a longitudinal database facility and Data Supplier Encryption Keys (K2) which are specific by data supplier. Additionally, the encryption key generation module may generate token-based keys for further encryption of data attributes at various stages of the data assembly. The encryption module comprises methods that doubly encrypt one or more retrieved patient-identifying attributes using keys K1 and K2 at a data supplier site. The encryption module also includes methods for partially decrypting the doubly encrypted data attributes at the longitudinal database facility. The encryption module may also include methods for optional re-encryption of the data attributes using a third key (e.g., a toke-based key) at the same facility.

The computer-readable medium may also include an HIPAA compliance module having methods that place selected patient-identifying attributes in an HIPPA compliant format. Further, the computer-readable medium may include common auditing methods, logging methods and Exception/Error handling methods.

Further features of the invention, its nature and various advantages, will be more apparent from the accompanying drawings and the following detailed description.

### BRIEF DESCRIPTION OF THE DRAWINGS AND A LISTING OF ACRONYMS

FIG. 1, which is reproduced from U.S. patent application Ser. No.______, is a block diagram of an exemplary system for assembling a longitudinal database from multi-sourced patient data records. The encryption applications described herein may be implemented in the system of FIG. 1, in accordance with the principles of the present invention.

FIGS. 2a-d, which are reproduced from U.S. patent application Ser. No.______, illustrate exemplary data supplier input and output file formats conforming to formats required by the software applications that are used to process patient data records, in accordance with the principles of the present invention.

FIG. 3, which is reproduced from U.S. patent application Ser. No.______, illustrates exemplary structure and formats of various encryption keys deployed in the software applications for processing patient data records, in accordance with the principles of the present invention.

FIGS. 4a-c, which are reproduced from U.S. patent application Ser. No.______, illustrate exemplary data source audit file formats and audit reports generated by the software applications for processing patient data records, in accordance with the principles of the present invention.

FIGS. 5a-c, which are reproduced from U.S. patent application Ser. No.______, illustrate exemplary audit file formats and audit reports generated by the software applications for processing patient data records, in accordance with the principles of the present invention.

For convenience in description herein, use may be made of acronyms and abbreviations. Some of the acronyms and abbreviations that are used are shown in the table below:
PPS Private Privacy Standard
HIPAA Health Insurance Portability and Accountability Act
LDF Longitudinal Database Facility
NCPDP National Council for Prescription Drug Programs
AES Advanced Encryption Standard
JCE Java Cryptography Extension
SHA1 Secure Hash Algorithm1
DOB Date of Birth
HMAC Hash (Key) Message Authentication Code

### DESCRIPTION OF THE INVENTION

Encryption applications are designed to provide double encryption functionality at data supplier sites and at a longitudinal database facility (“LDF”). The encryption applications can be integrated with other software applications to provide a double encryption/matching solution to the problem of constructing longitudinal databases from de-identified patient records. The encryption applications are designed so that incoming data records are processed in a manner consistent with specific private initiative requirements for eliminating all risk of inadvertent or deliberate misuse of patient information at the LDF or other sites.

An exemplary set of encryption applications is designed to enable data suppliers to provide doubly encrypted data records (transaction records) in which the patient attributes are formatted in an industry-accepted secure encrypted format. Additionally, the encryption applications are designed so that the data attributes have an encryption format which allows the LDF to link multi-sourced data records individual by individual, but which precludes the LDF from learning the identities or any other sensitive personal information relating to the individuals.

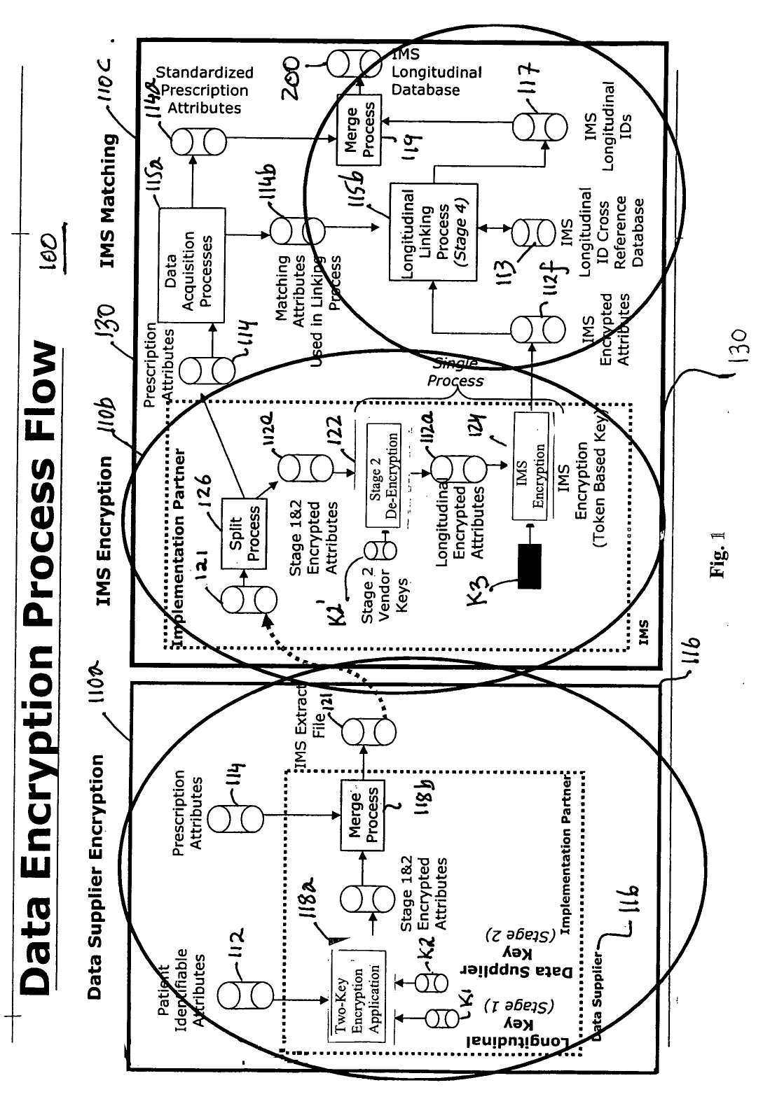

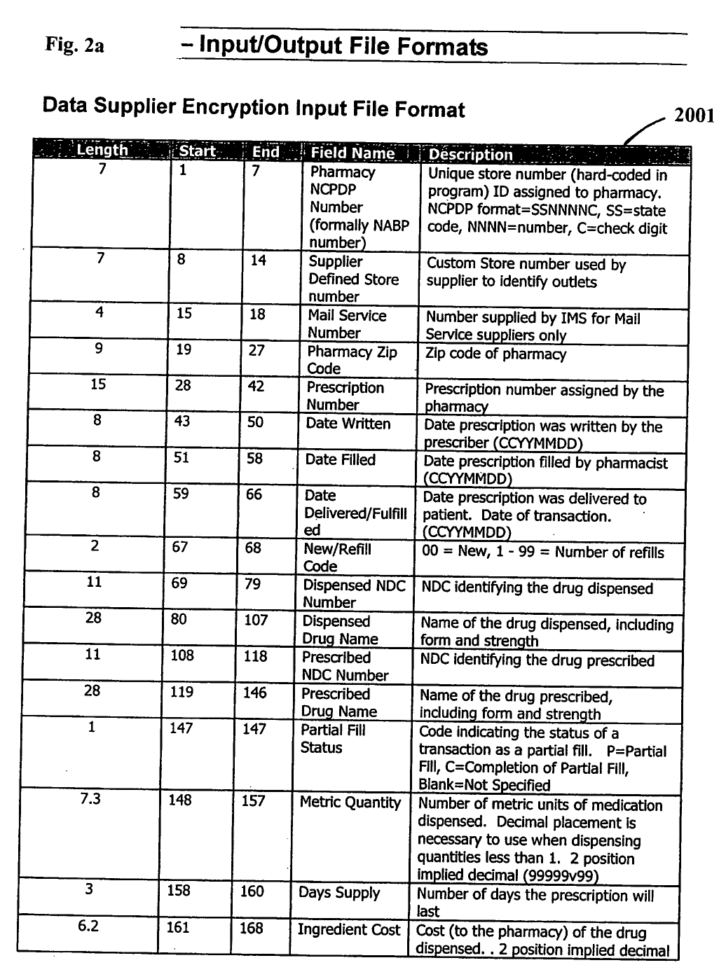

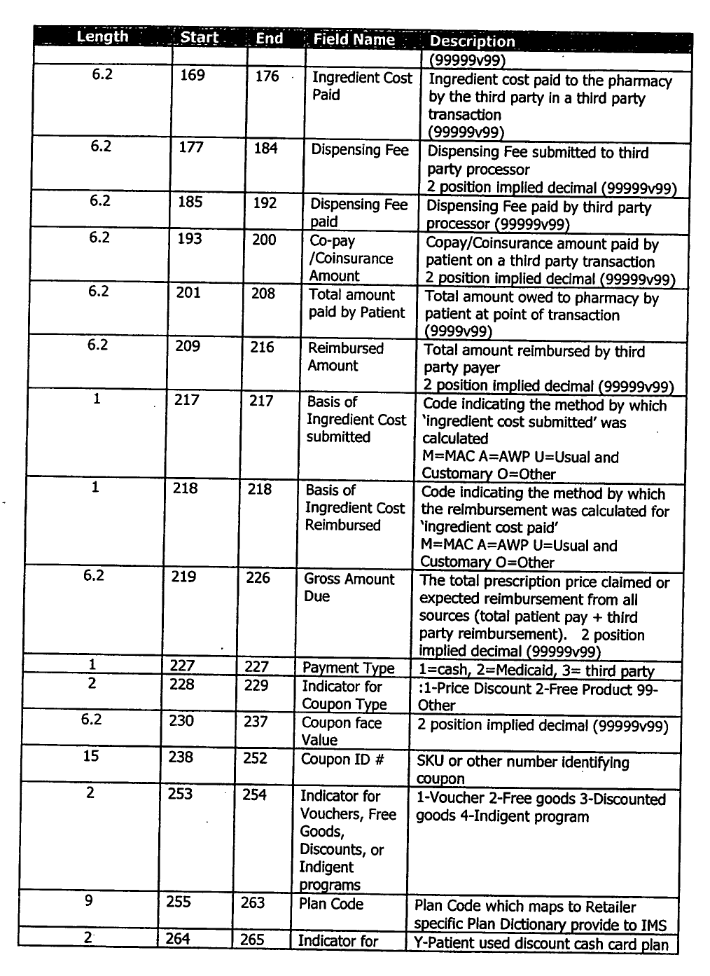

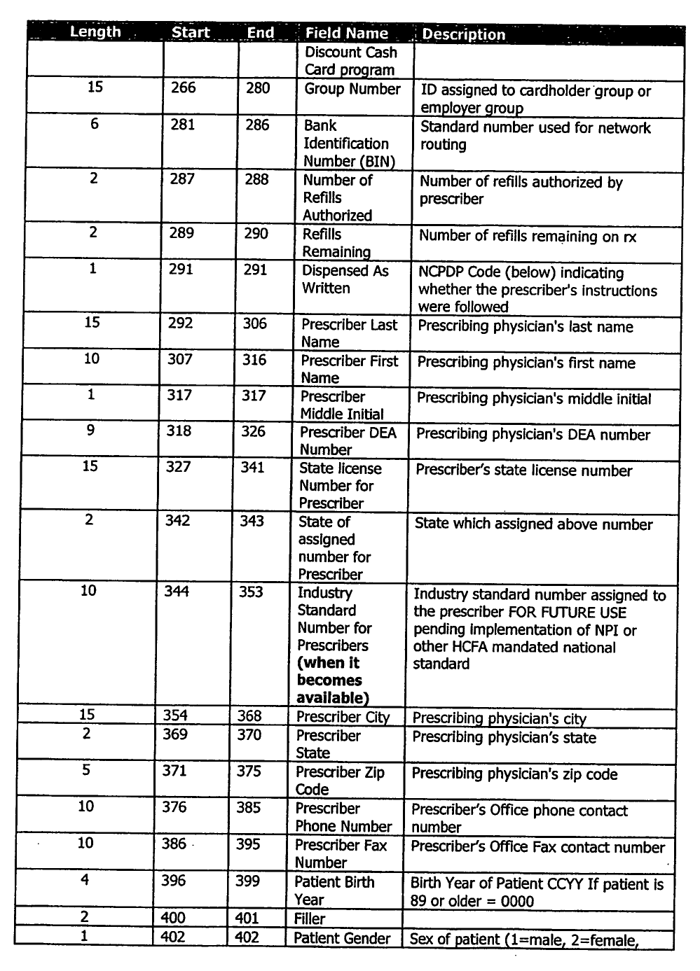

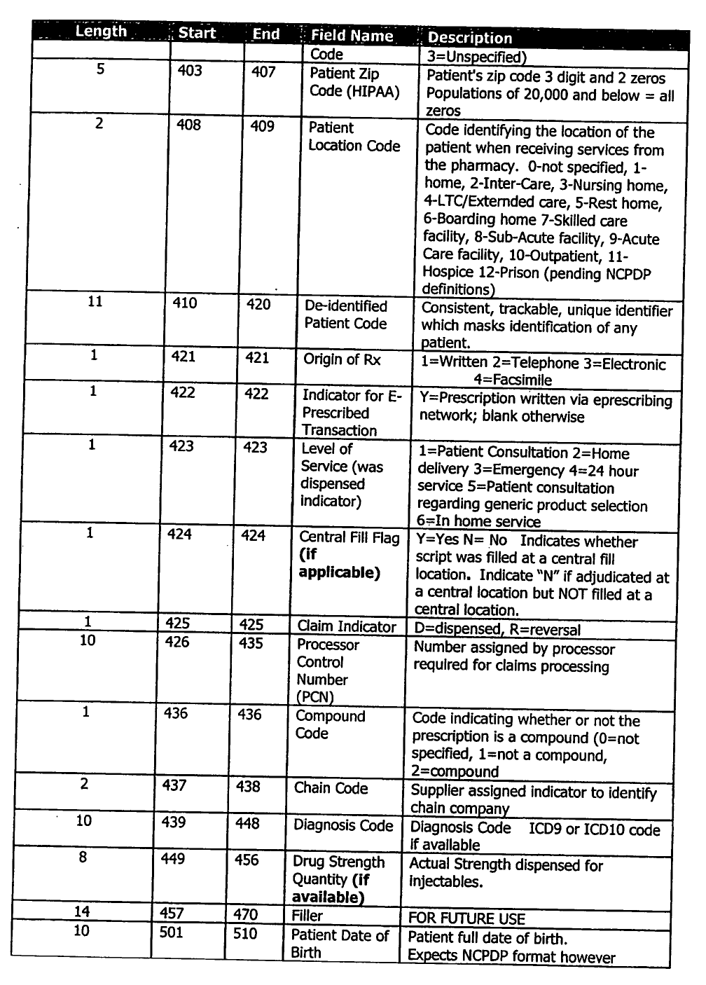

The exemplary set of encryption applications includes a Data Supplier Encryption Application, an LDF Encryption Application, a Key Generation Application and a Report Generation Application. The applications may be written in any suitable computer programming language(s) and may be implemented on any suitable computer or networking hardware systems for integrated operation across data supplier sites and the LDF. (See e.g., FIG. 1).

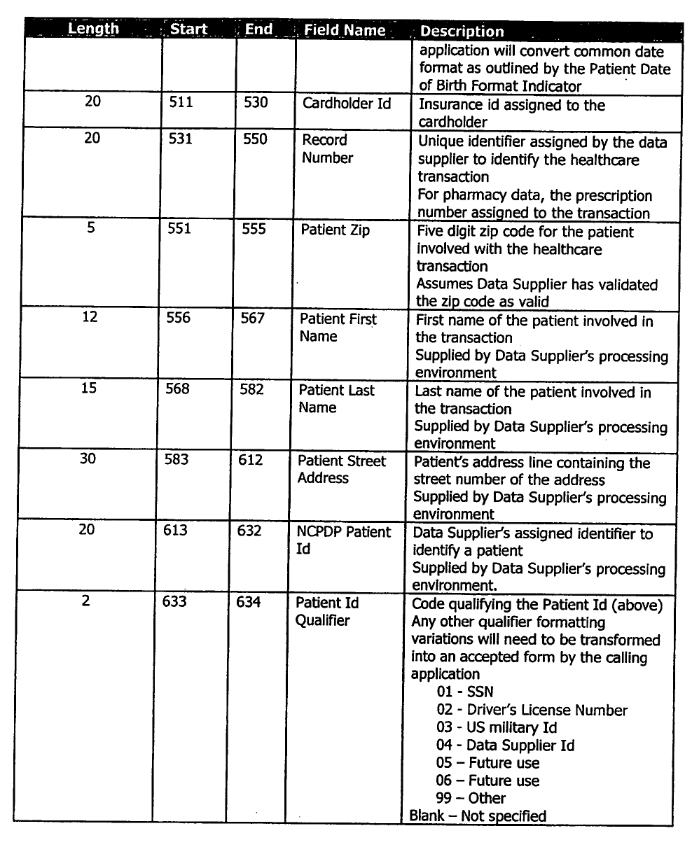

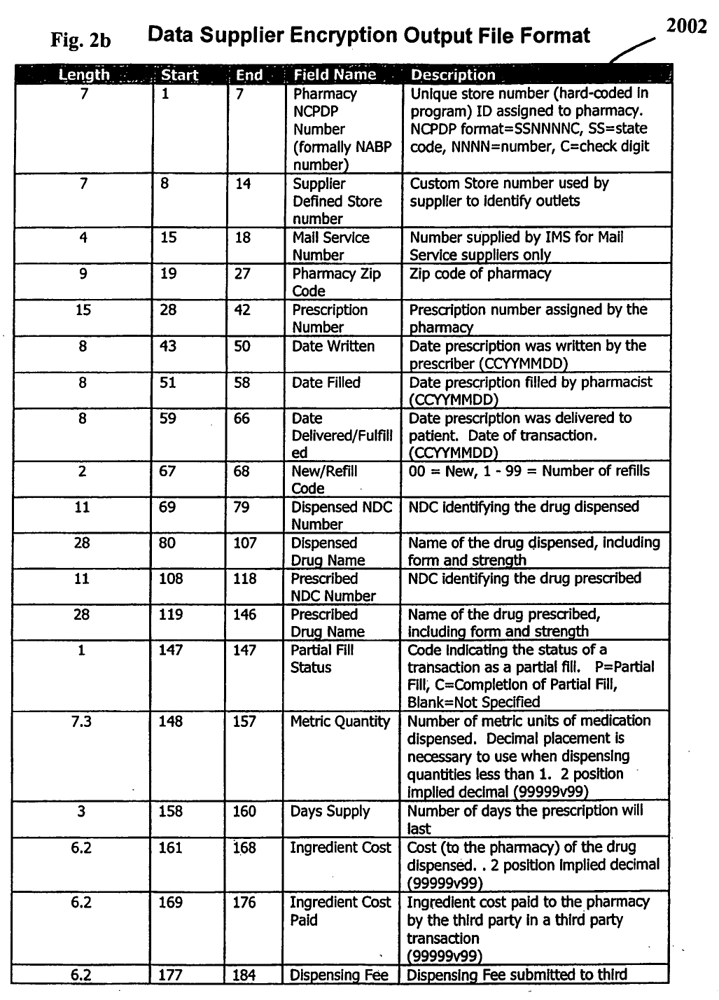

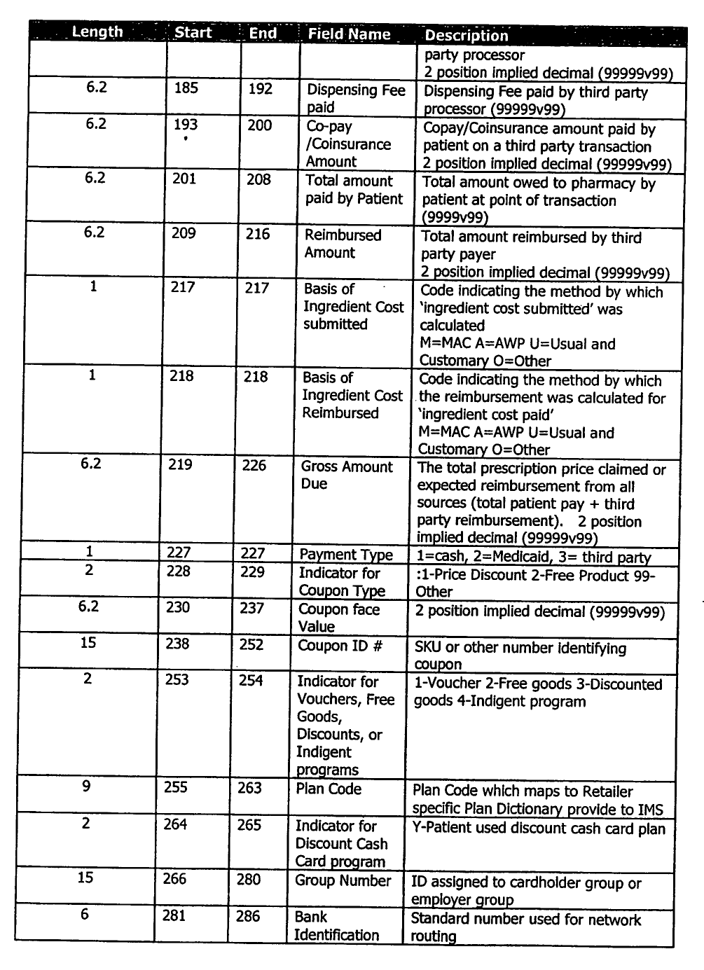

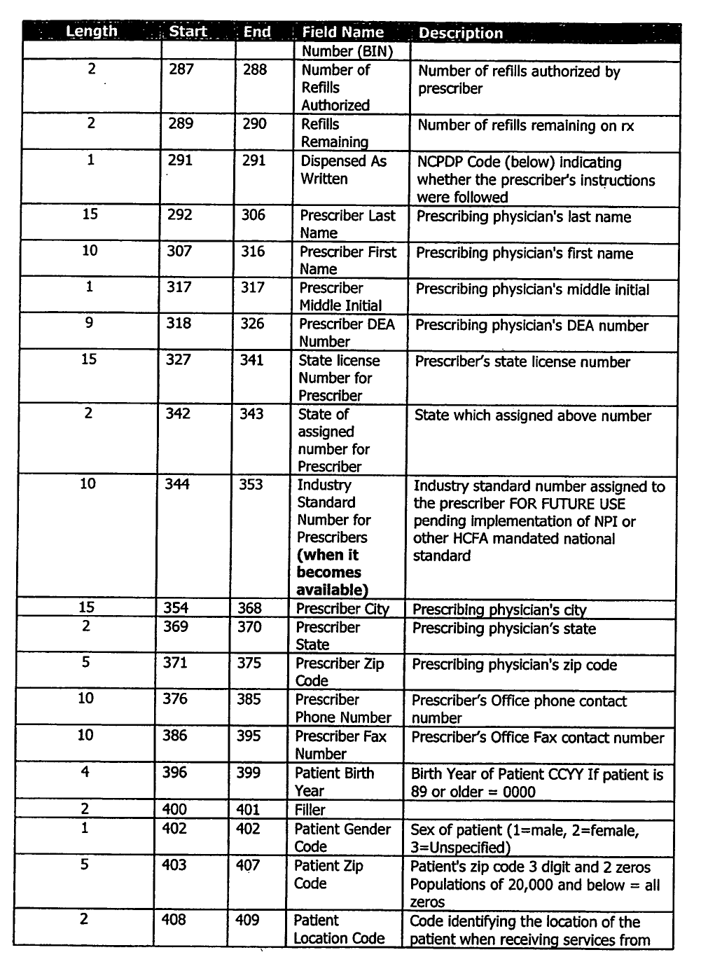

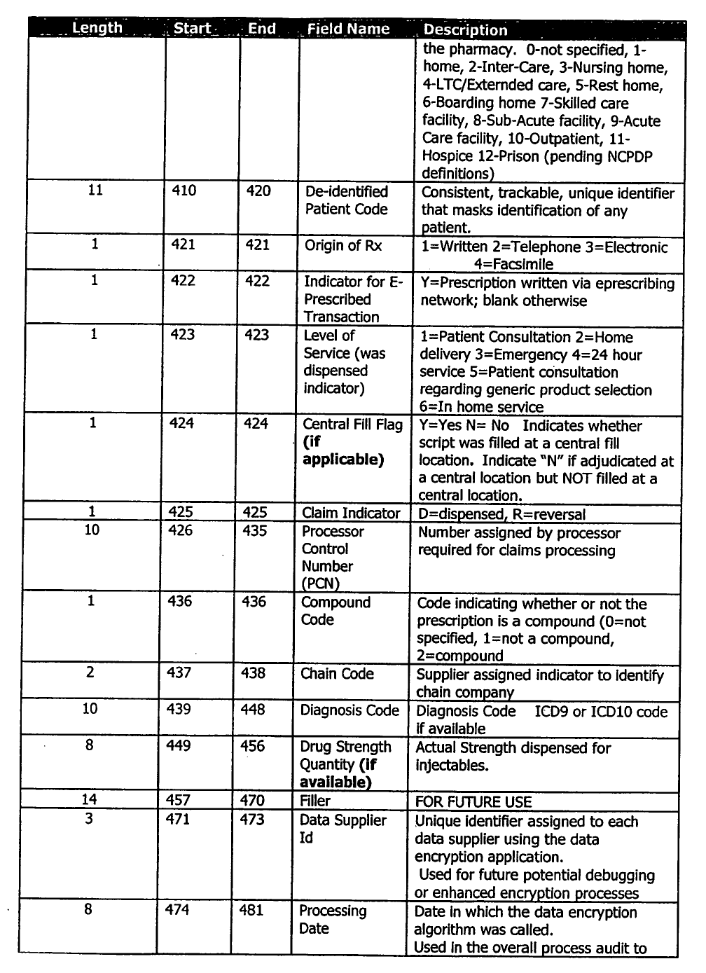

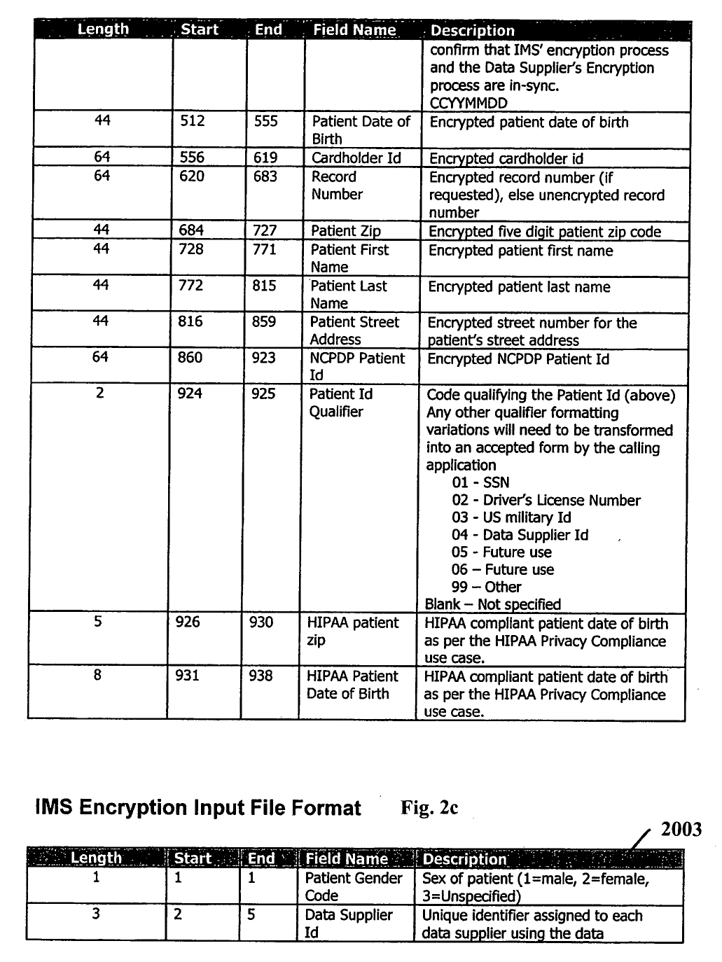

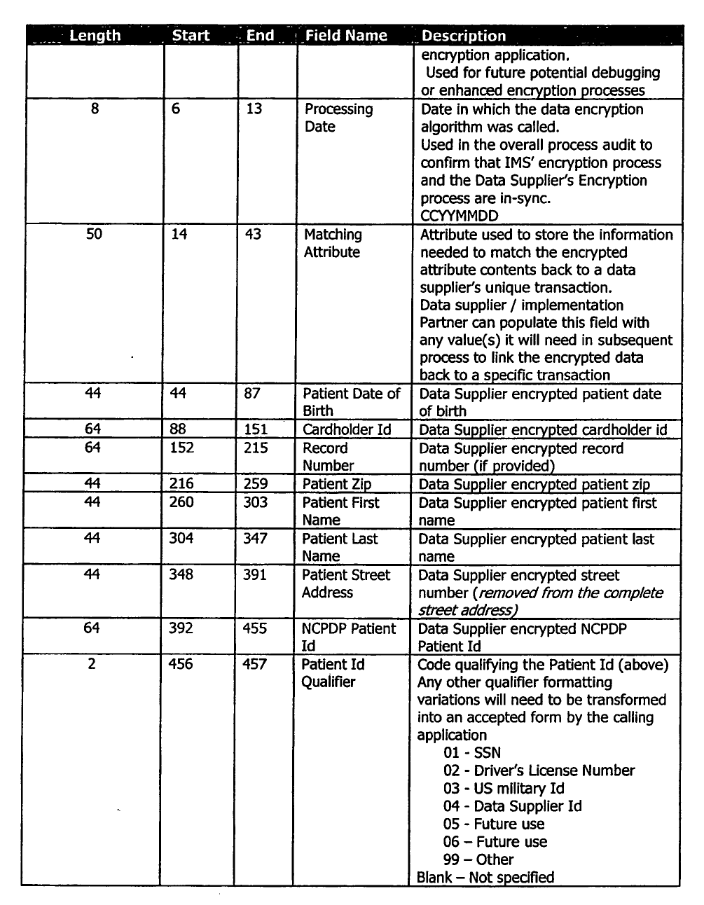

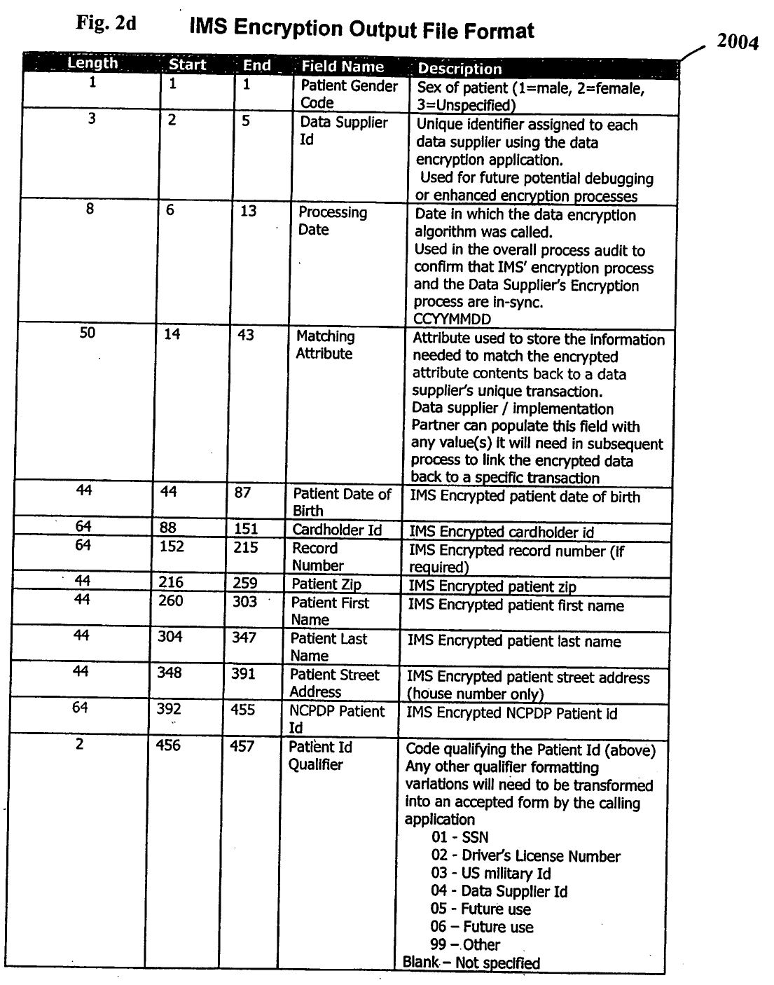

Each of the applications may be designed to accept suitably formatted input data files and generate suitably formatted output data files. For example, the Data Supplier Encryption Application may be used to process a Data Supplier Input File so as to generate a Data Supplier Encrypted Output file. (See e.g., FIGS. 2a and 2b). Similarly, the LDF Encryption Application may be used to process an LDF Input File so as to generate an LDF Supplier Encrypted Output file. (See e.g., FIGS. 2c and 2d). The input data files may have standardized fixed length formats. An input file may consist of data records related to healthcare transactions and personal patient information. In a data record with a standardized format, data fields or attributes related to personal information may be placed at the end of the data record behind healthcare transaction data. In one format variation, as an exception, a “Patient Gender” attribute may be placed in the middle of the data record in between healthcare transaction data. The applications are designed to process the input data files so that personal information attributes (e.g., those placed at the end of a data record or in the middle of the data record) are read, standardized, made HIPAA compliant, and doubly encrypted.

The output from the encryption applications is written into a fixed length format file. The encrypted attributes may be placed at the end of the record containing transaction data (See e.g., FIGS. 2b and 2d). An encrypted attribute placed in a data field may be padded if necessary to increase the size of the encrypted attribute to match the designated data field size for that attribute in a standardized data record format.

A version of the set of applications is designed to utilize methods and functions organized as a set of classes or modules. The applications utilize the methods and functions to transform data attributes read from the input files. This set of modules may include the following named modules:
Configuration,
Acquire Attributes,
Key Derivation and Integrity Check,
Standardization,
HIPAA Compliance,
Encryption,
Secure Audit Generation, and
File Output

Common framework components may be used across one or more of these modules. The common framework components may, for example, include Auditing, Logging and Exception/Error handling routines. In addition, an independent reporting tool/utility may be associated with the applications for generating audit reports. For purposes of illustration, exemplary features of a few of these modules are described in further detail below.

The Configuration module is designed to read system and data information from a configuration file and to load such information into memory for use within the applications later on. An exemplary configuration file may contain the following information: Input attribute names, start and end locations, desired log level, format Indicators, Data Supplier ID, option to indicate encryption and standardization, option to indicate need for HIPAA compliance, record delimiter and name and location of various files.

The Configuration module may include functions/methods for initializing variables, and data access methods for retrieving information (e.g., data location and values) to the calling application or program. Appendix A lists an exemplary set of methods that may be included in the Configuration module.

The Acquire Attributes module includes data access methods, which retrieve attributes from data files for further processing. The Standardize, HIPAA compliance and Encryption modules may use a set of defined data access methods (e.g., Class PPS Variable methods) in the Acquire Attributes module to retrieve and set values to the attributes after each activity. The PPS variable context is used by each of these modules to get the value, perform the necessary activity (e.g., Standardization, HIPAA compliance or encryption) and then set the values. Like the Configuration module, these modules may include methods for initializing variables, and data access methods for getting information (e.g., data location and values) to the calling application or program. Appendix B lists an exemplary set of data access methods that may be available in the Standardize, HIPAA compliance and Encryption modules.

Another set of methods (e.g., Class PPSProcessor functions) may be used in the application modules to parse a subject input file for attributes which should be standardized, made HIPAA compliant, or encrypted. Information on the names of the attributes that should be read and the locations of these attributes are acquired by using the Class PPSProcessor methods from the Configuration module.

In typical process flow, the data records from the input file may be read, for efficiency, in large chunks and loaded into computer memory. The attributes related to personal information may be extracted from the records for separate processing. Appendix C lists exemplary Class PPS Variable Data access methods that may be included in the Standardize, HIPAA compliance and Encryption modules. All attributes, which should be standardized (e.g., attributes identified under the applicable Private Privacy Standard), are then passed through a respective standardization process. Next, the HIPAA compliance methods may be invoked for those attributes which require HIPAA compliance. Finally, the encryption methods may be invoked for those attributes which should be encrypted. Appendix D lists exemplary features of the Class PPSProcessor methods in the Acquire Attributes module that are made available to the Standardize, HIPAA compliance and Encryption modules.

An initialization method in this class (e.g., public void process (PPSConfig)) provides a handle to the PPSConfig class. The initialization method reads all the attributes present in the subject data file. Further, the initialization method can invoke the get data methods from PPSConfig class to populate the variables with corresponding attribute names.

The Key Derivation And Integrity Check module may include specific methods (e.g., Class PPSGenerateKey) to generate encrypted versions of the Data Supplier Longitudinal Encryption Key (e.g., key K1, FIG. 1) and Data Supplier Encryption Key (e.g., key K2, FIG. 1) for use by the Encryption Application. Appendix E lists exemplary features of the Class PPSGenerateKey( ) method and other methods in the Key Derivation module. This class reads the encrypted keys and decrypts the keys for use by the Encryption applications. This class also creates a secure encrypted key using the key derived in the MOL derive key module. Other class methods may be utilized in the Key Generation application. One of these methods (e.g., Class PPSDeriveKey) may be used to derive a key, which can be used to encrypt the Data Supplier Longitudinal Encryption Key K1 and Data Supplier Encryption key K2. Other methods (e.g., Class PPSSecure Encryption Key) may be used to securely store keys K1 and K2 in the respective key files. Further, Class PPSKey Generator methods may be available for generating encrypted versions of keys K1 and/or K2.

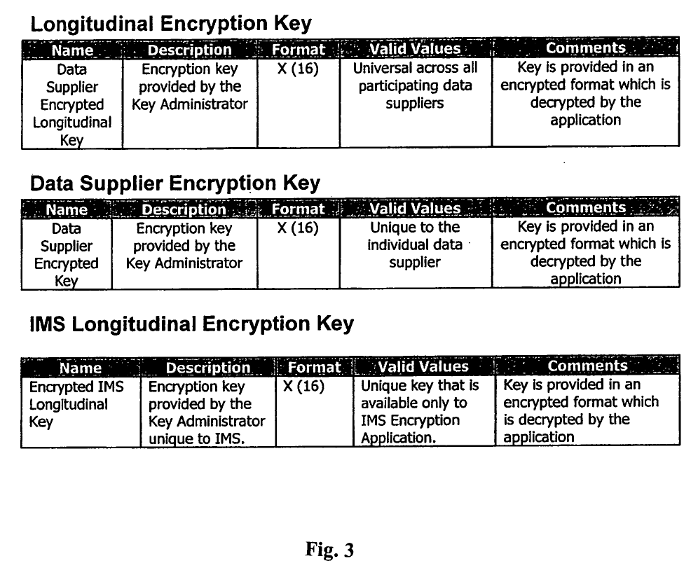

The Key Derivation module also includes public methods (e.g., Class Public Utility) which allow the other modules or applications to use the encryption method defined in the PPSEncrypt and PPSDecrypt classes. For example, the Encryption module may use the Class Public Utility methods for encryption and/or decryption of the keys K1 and K2. FIG. 3 shows the exemplary structure and formats of various encryption keys that are generated using the methods in the Key Derivation module.

The Standardization module (e.g., ClassPPSStandardize) includes methods that may be used by a calling application to standardize attributes in the input data records. The set of data attributes, which may be standardized, includes, for example, Patient Date of Birth, Patient Gender, Cardholder ID, Record Number, Patient Zip Code, Patient First Name, Patient Last Name, Data Supplier Patient ID, Patient Street Address. The standardized attributes are available at the output of the standardization process. Appendix F lists exemplary features of the methods of this class.

The HIPAA compliance module methods (e.g., Class PPSHipaa) are designed to create HIPAA compliant attributes for Patient Date of Birth and Patient Zip Code attributes. Methods of this module may be invoked, for example, when HIPAA compliance of the Patient Date of Birth and Patient Zip Code attributes is required or desired at the particular Data supplier's end. The application acquires this information and makes either one or both of these attributes HIPAA compliant as required or desired. Appendix G lists exemplary features of the compliance methods that may be included in the HIPAA compliance modules.

The Encryption module includes methods (e.g. Class PPSEncrypt) which encrypt the attributes selected for encryption and also encode the encrypted attributes. The encryption process takes the encryption keys (e.g., keys K1 and K2) and the data to be encrypted as input. The data undergoes encryption first with the Data Supplier Longitudinal Encryption Key (K1). The encrypted result then undergoes another round of encryption with the Data Supplier Encryption Key (K2). The final doubly encrypted result is then encoded. Encoding is desirable to convert the result of encryption, which is binary data, into a form that is suitable for storage and transmission.

Suitable symmetric key algorithms may be used as the encryption mechanism. For example, the Advanced Encryption Standard (AES) algorithms, which are a Federal Information Processing Standard, may be used the encryption mechanism. The double encrypted output may be encoded using a Base 64 encoding mechanism. The encrypted attributes may include Patient Data of Birth, Cardholder ID, Record Number (if required), Patient Zip Code, Patient First Name, Patient Last Name, Data Supplier Patient ID, and Patient Street Address.

The Encryption module also includes methods for decryption. These may be utilized, for example, for decryption of the AES Encryption key generated by the Key Derivation module. Appendix H lists exemplary features of the encryption and decryption methods that may be included in the Encryption module.

In typical configurations of the applications for processing the data records, a list of data attributes or fields that are identified as needing standardization, HIPAA compliance and encryption are fixed within the applications. Out of this list of fixed attributes, any number of attributes may be removed if standardization, HIPAA compliance and encryption are not required in actual input data records. However, no new or additional attributes other than the fixed attributes would be processed by the applications through the three processes (standardization, HIPAA compliance and encryption).

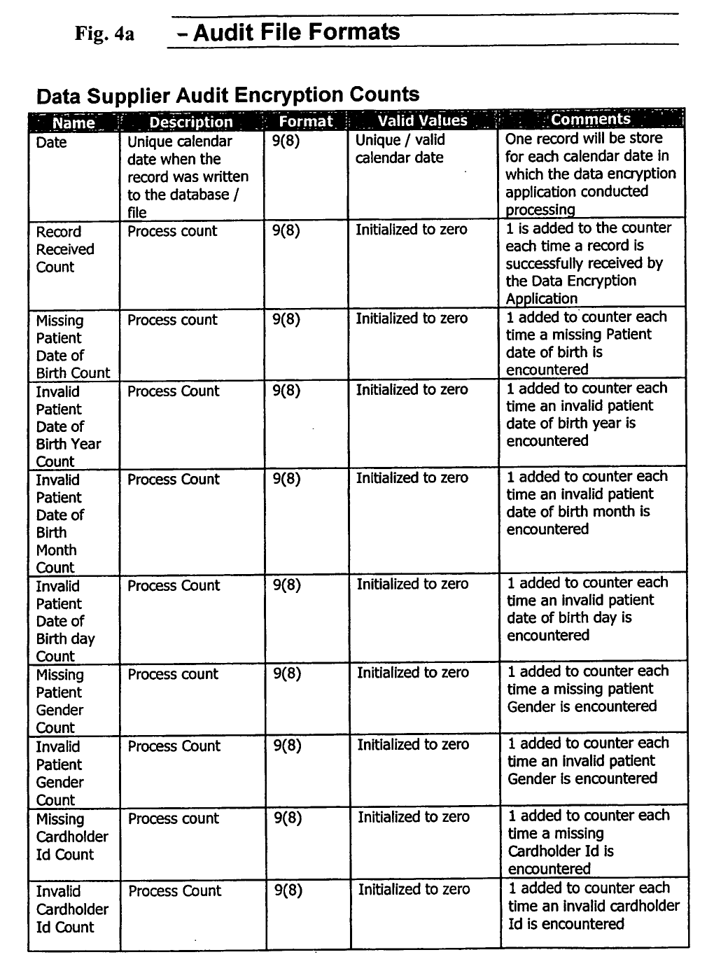

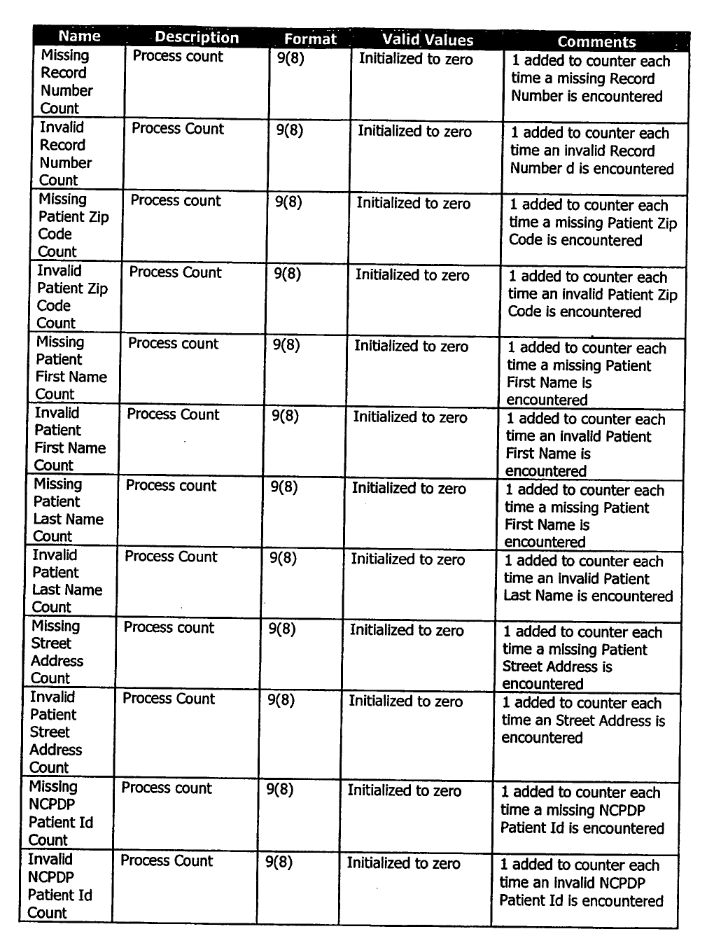

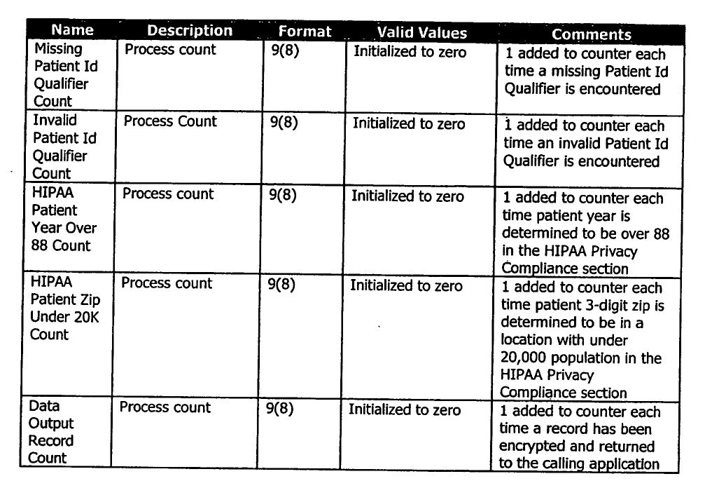

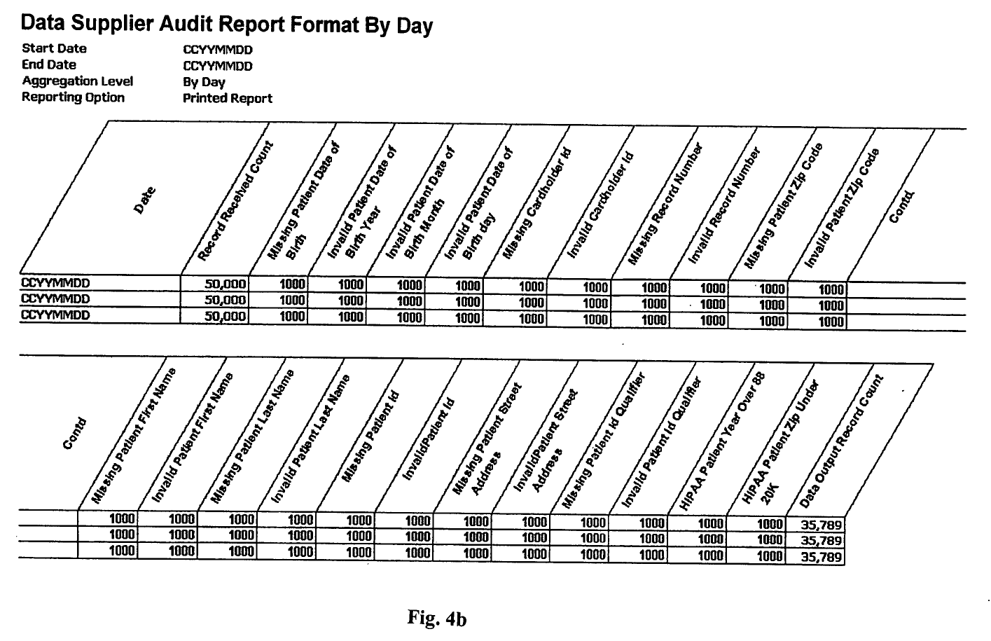

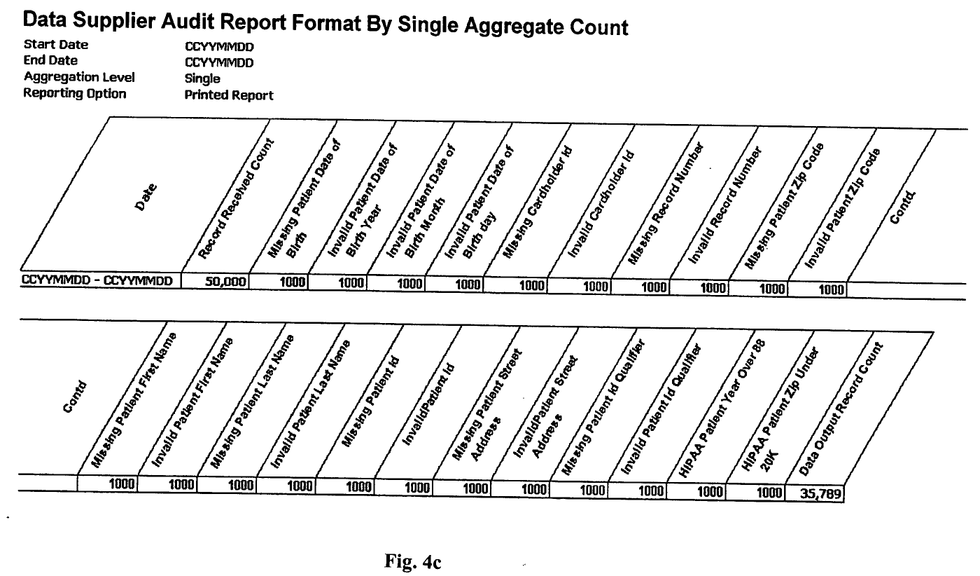

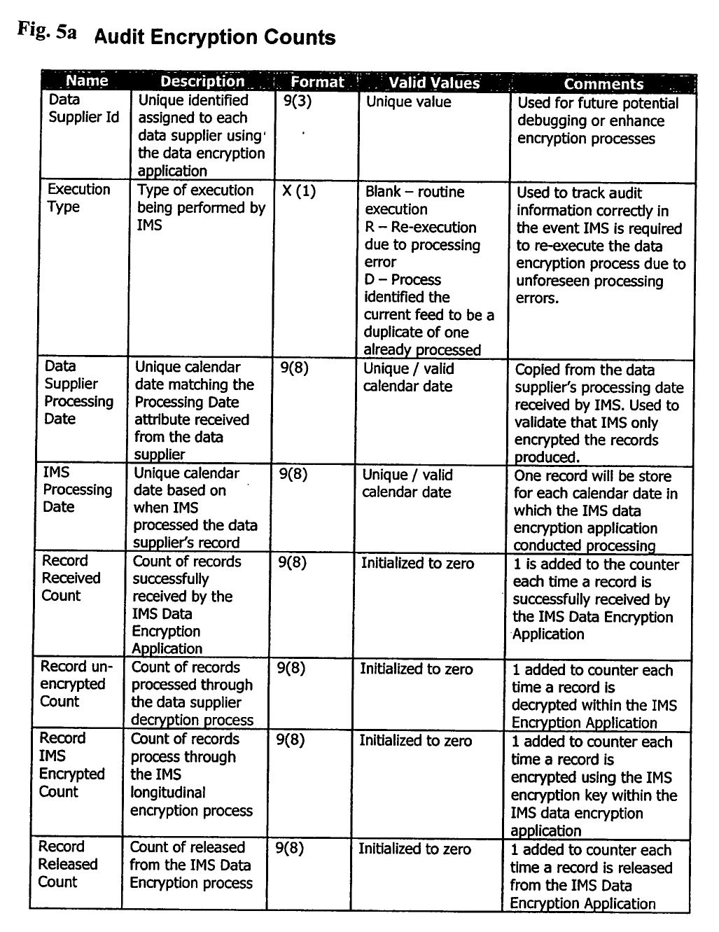

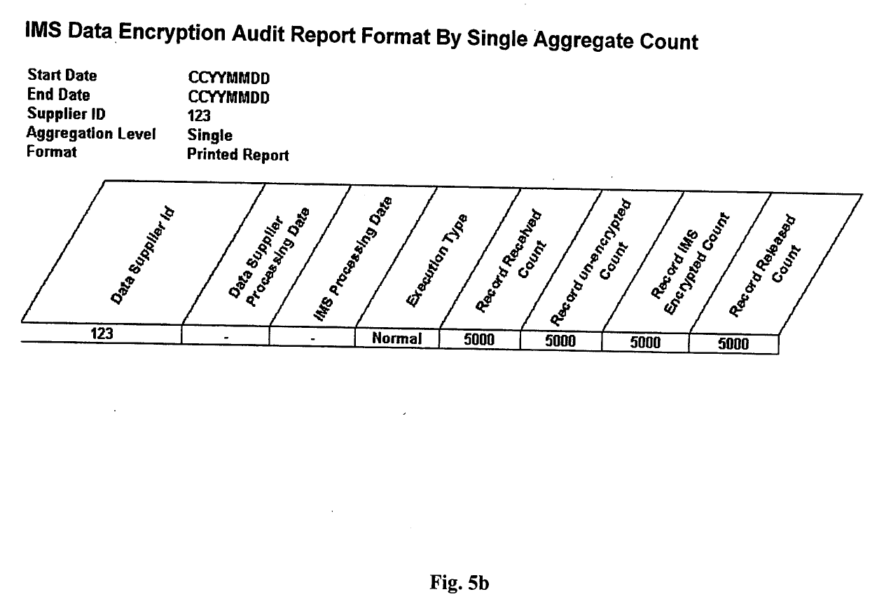

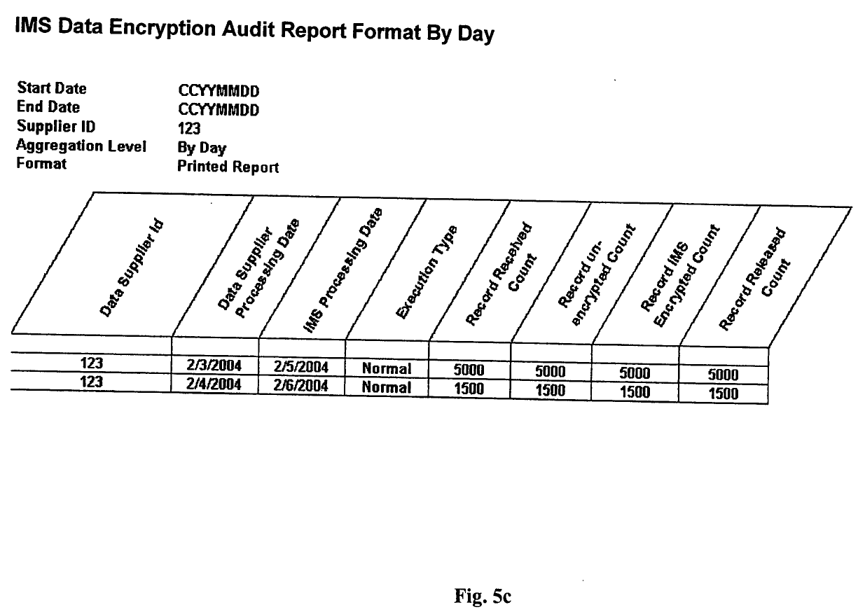

The Secure Audit Generation Module (e.g., Class PPSAudit) includes methods for maintaining all audit counters, the audit file and its data integrity. This class checks for file integrity while getting initialized. The Standardization, HIPAA compliance and Encryption modules use the methods of this class for audit and data integrity checks. Only one instance of this class may exist through the entire lifetime of the encryption application process. Appendix I lists exemplary features of the methods that may be included in the Secure Audit Generation Module. FIGS. 4a and 5a respectively show the formats of an exemplary data supplier audit file and encryption counts audit file that may be generated using the Secure Audit Generation methods.

The File Output Module includes methods (e.g., Class PPSReport) that are designed to read from the audit file and print an audit report into an output file. A report generation utility (e.g., Class PPSReportGenerator) may be used to generate the audit report. Appendix J lists exemplary features of the methods that may be included in the File Output Module. FIGS. 4b and 4c show the formats of exemplary data source audit reports generated by the software applications for processing patient data records. Similarly, FIGS. 5b and 5c show the formats of exemplary LDF audit reports that may be generated by the File Output methods.

Additionally, a class of exception methods may be included in the applications to handle all exceptions that may occur during the execution of the applications. This class is used to create objects that can hold the built-in exception thrown by an application and/or a string that corresponds to the exception message. Appendix K lists exemplary exception methods that may be included in the applications.

In an exemplary implementation, the applications/modules are designed to be capable of handling two million or more data supplier records during a process run. As previously mentioned, the common framework components that are used across all or several of the application modules include
1. Auditing framework
2. Logging framework
3. Exception/Error handling framework

In accordance with the present invention, the methods or functions described herein can be provided on computer-readable media. It will be appreciated that each of the methods (described above in accordance with this invention), and any combination of these methods, can be implemented by computer program instructions. These computer program instructions can be loaded onto a computer or other programmable apparatus to produce a machine, such that the instructions, which execute on the computer or other programmable apparatus create means for implementing the methods and functions described herein. These computer program instructions can also be stored in a computer-readable memory that can direct a computer or other programmable apparatus to function in a particular manner, such that the instructions stored in the computer-readable memory produce an article of manufacture including instruction means which implement the methods or functions. The computer program instructions can also be loaded onto a computer or other programmable apparatus to cause a series of operational steps to be performed on the computer or other programmable apparatus to produce a computer implemented process such that the instructions which execute on the computer or other programmable apparatus provide steps for implementing the methods or functions. It will also be understood that the computer-readable media on which instructions for implementing the aforementioned applications, methods and functions are being provided, include without limitation, firmware, microcontrollers, microprocessors, integrated circuits, ASICS, and other available media.

The foregoing merely illustrates the principles of the invention. Various modifications and alterations to the described embodiments will be apparent to those skilled in the art in view of the teachings herein. It will thus be appreciated that those skilled in the art will be able to devise numerous techniques which, although not explicitly described herein, embody the principles of the invention and are thus within the spirit and scope of the invention.

### APPENDIX A

### Configuration Module Class Functions and Methods

Operations
public void init( )
Parameter None
Description This method initializes all the variables from the properties file. Here we perform all the necessary checks for the values read from file and perform necessary logging.
   Note: For all file location read we ensure that the path to the file has been specified. If no path is specified then the system will log a message and exit. (if the log file is not present then it will log a message to the console and exit)
Returns None
Validations None
Exceptions PPSException

### APPENDIX B

### Data Access Module Class Functions and Methods

public String getLogFile( )
Parameter None
Description This method returns the Log File location read from the properties file to the calling program.
Returns String
public String getLongitudinalEncryptionKeyFile( )
Parameter None
Description This method returns the data supplier longitudinal key file location read from the properties file to the calling program.
Returns String
public String getDataSupplierEncryptionKeyFile( )
Parameter None
Description This method returns the data supplier encryption key file location read from the properties file to the calling program.
Returns String
public String getDataSupplierlnputFile( )
Parameter None
Description This method returns the data supplier input file location read from the properties file to the calling program.
Returns String
public String getDataSupplierOutputFile( )
Parameter None
Description This method returns the data supplier output file location read from the properties file to the calling program.
Returns String
public String getAuditFile( )
Parameter None
Description This method returns the audit file location read from the properties file to the calling program.
Returns String
public String getSecureAuditFile( )
Parameter None
Description This method returns the secure audit file location read from the properties file to the calling program.
Returns String
public String getFirstNameStandardizationFile( )
Parameter None
Description This method returns the first name standardization file location read from the properties file to the calling program.
Returns String
public String getHipaaZipCodeReferenceFile( )
Parameter None
Description This method returns the HIPAA zip code reference file location read from the properties file to the calling program.
Returns String
public String getPatientDateOfBirth( )
Parameter None
Description This method returns the Patient Date Of Birth read from the properties file to the calling program.
Returns String
public String getPatientDateOfBirthStart( )
Parameter None
Description This method returns the Patient Date Of Birth Start location read from the properties file to the calling program.
Returns String
public String getPatientDateOfBirthEnd( )
Parameter None
Description This method returns the Patient Date Of Birth End location read from the properties file to the calling program.
Returns String
public String getCardholderID( )
Parameter None
Description This method returns the Cardholder ID read from the properties file to the calling program.
Returns String
public String getCardholderIDStart( )
Parameter None
Description This method returns the Cardholder ID Start location read from the properties file to the calling program.
Returns String
public String getCardholderIDEnd( )
Parameter None
Description This method returns the Cardholder ID End location read from the properties file to the calling program.
Returns String
public String getRecordNumber( )
Parameter None
Description This method returns the record number read from the properties file to the calling program.
Returns String
public String getRecordNumberStart( )
Parameter None
Description This method returns the record number start location read from the properties file to the calling program.
Returns String
public String getRecordNumberEnd( )
Parameter None
Description This method returns the record number end location read from the properties file to the calling program.
Returns String
public String getPatientZip( )
Parameter None
Description This method returns the patient zip read from the properties file to the calling program.
Returns String
public String getPatientZiPPStart( )
Parameter None
Description This method returns the patient zip start location read from the properties file to the calling program.
Returns String
public String getPatientZipEnd( )
Parameter None
Description This method returns the patient zip end location read from the properties file to the calling program.
Returns String
public String getPatientFirstName( )
Parameter None
Description This method returns the patient first name read from the properties file to the calling program.
Returns String
public String getPatientFirstNameStart( )
Parameter None
Description This method returns the patient first name start location read from the properties file to the calling program.
Returns String
public String getPatientFirstNameEnd( )
Parameter None
Description This method returns the patient first name end location read from the properties file to the calling program.
Returns String
public String getPatientLastName( )
Parameter None
Description This method returns the patient last name read from the properties file to the calling program.
Returns String
public String getPatientLastNameStart( )
Parameter None
Description This method returns the patient last name start location read from the properties file to the calling program.
Returns String
public String getPatientLastNameEnd( )
Parameter None
Description This method returns the patient last name end location read from the properties file to the calling program.
Returns String
public String getPatientStreetAddress( )
Parameter None
Description This method returns the patient street address read from the properties file to the calling program.
Returns String
public String getPatientStreetAddressStart( )
Parameter None
Description This method returns the patient street address start location read from the properties file to the calling program.
Returns String
public String getPatientStreetAddressEnd( )
Parameter None
Description This method returns the patient last name end location read from the properties file to the calling program.
Returns String
public String getNCPDPPatientID( )
Parameter None
Description This method returns the NCPDP patient id read from the properties file to the calling program.
Returns String
public String getNCPDPPatientIDStart( )
Parameter None
Description This method returns the NCPDP patient id start location read from the properties file to the calling program.
Returns String
public String getNCPDPPatientIDEnd( )
Parameter None
Description This method returns the NCPDP patient id end location read from the properties file to the calling program.
Returns String
public String getPatientIDQualifier( )
Parameter None
Description This method returns the patient id qualifier location read from the properties file to the calling program.
Returns String
public String getPatientIDQualifierStart( )
Parameter None
Description This method returns the patient id qualifier start location read from the properties file to the calling program.
Returns String
public String getPatientIDQualifierEnd( )
Parameter None
Description This method returns the patient id qualifier end location read from the properties file to the calling program.
Returns String
public String getDateOfBirthFormat( )
Parameter None
Description This method returns the date of birth format specified in the properties file to the calling program.
Returns String
public String getGenderFormat( )
Parameter None
Description This method returns the Gender format specified in the properties file to the calling program.
Returns String
public String getBufferSize( )
Parameter None
Description This method returns the Buffer Size specified in the properties file to the calling program.
Returns String
public boolean getHipaatizeAttributes( )
Parameter None
Description This method returns that if HIPAA compliance value (“Yes” or “No”) specified in the properties file to the calling program.
Returns boolean
public String getEncryptRecordNumber( )
Parameter None
Description This method returns encrypt record number value (“Yes” or “No”) specified in the properties file to the calling program.
Returns String
public String getStandardizeGender( )
Parameter None
Description This method returns standardize gender value (“Yes” or “No”) specified in the properties file to the calling program.
Returns String
public byte[] getDataSupplierEncryptionKey( )
Parameter None
Description This method returns the data supplier encryption key.
Returns Byte[]
public void setDataSupplierEncryptionKey( )
Parameter None
Description This method sets the data supplier encryption key.
Returns None
public byte[] getLongitudinalEncryptionKey( )
Parameter None
Description This method returns the longitudinal encryption key.
Returns Byte[]
public void setLongitudinalEncryptionKey( )
Parameter None
Description This method sets the longitudinal encryption key.

### APPENDIX C

### PPS Variable Data Access and Processor Methods in Standardization, HIPAA Compliance and Encryption Modules

Operations
Public void extractVariables(String)
Parameter String—This string represents one record read from the input buffer.
Description This method sets the values of all the attributes read from the configuration file, with appropriate values read from the input record.
Returns String
Data Access
public String getPatientDateOfBirthValue( )
Parameter None
Description This method gets the value of the patient date of birth.
Returns String
Public void setPatientDateOfBirthValue( )
Parameter String
Description This method sets the value of the patient date of birth.
Returns None
public String getCardholderIDValue( )
Parameter None
Description This method gets the Cardholder ID
Returns String
public void setCardholderIDValue( )
Parameter String
Description This method sets the Cardholder ID
Returns None
public String getRecordNumberValue( )
Parameter None
Description This method gets the record number.
Returns String
public void setRecordNumberValue( )
Parameter String
Description This method sets the record number.
Returns None
public String getPatientZipValue( )
Parameter None
Description This method gets the patient zip value.
Returns String
public void setPatientZipValue( )
Parameter String
Description This method sets the patient zip value.
Returns None
public String getPatientFirstNameValue( )
Parameter None
Description This method gets the patient first name value.
Returns String
public void setPatientFirstNameValue( )
Parameter String
Description This method sets the patient first name value.
Returns None
public String getPatientLastNameValue( )
Parameter None
Description This method gets the patient last name value.
Returns String
public void setPatientLastNameValue( )
Parameter String
Description This method sets the patient first name value.
Returns None
public String getPatientStreetAddressValue( )
Parameter None
Description This method gets the patient street address
Returns String
public void setPatientStreetAddressValue( )
Parameter String
Description This method sets the patient street address.
Returns None
public String getNCPDPPatientIDValue( )
Parameter None
Description This method gets the NCPDP patient id value.
Returns String
public void setNCPDPPatientIDValue( )
Parameter String
Description This method sets the NCPDP patient id value.
Returns None
public String getDataSupplierPatientIDQualifierValue( )
Parameter None
Description This method gets the data supplier patient id qualifier value.
Returns String
public void setDataSupplierPatientIDQualifierValue( )
Parameter String
Description This method sets the data supplier patient id qualifier value.
Returns None
public void setHipaaPatientZipValue( )
Parameter String
Description This method sets the HIPAA patient zip value.
Returns None
public void setHipaaPatientDateofBirthValue( )
Parameter String
Description This method sets the HIPAA patient date of birth value.
Returns None

### APPENDIX D

### Data Parsing Methods in Standardization, HIPAA Compliance and Encryption Modules

Class PPSProcessor:
Operations
public void process (PPSConfig)
Parameter PPSConfig—this method gets a handle to the PPSConfig class and reads all the attributes present in the file. It invokes the get methods from PPSConfig to populate the variables with attribute name.
Description This method performs the following
   a) Reads the input file
   b) Buffers the input file according to buffer size specified in the configuration file.
   c) Sorts the various attributes read from the configuration file, in ascending order according to the file location as specified in the configuration file.
   d) Invokes the ‘PPSVariable.extractVariables(readRecord)’ method to extract the values read from the input file.
   e) Invokes the ‘standardize(PPSVariable)’ method to standardize the attributes.
   f) Invokes the ‘hipaa (PPSVariable)’ method to make the attributes HIPAA compliant.
   g) Invokes the ‘PPSEncryption(PPS Variable)’ method to encrypt the attributes.
   h) Buffers the output.
   i) Write buffered output to the output file.
Returns None
Exceptions PPSException—Any exceptions that occur will be caught and thrown as custom PPSExceptions to the PPSException class.
public static void main ( )
Parameter None
Description This is the main method and calls the process method.
Returns None
Exceptions PPSException—Any exceptions that occur will be caught and thrown as custom PPSExceptions to the PPSException class.

### APPENDIX E

### Key Generation Methods

Class PPSGenerateKey: This class is used to generate the encrypted Data Supplier Longitudinal Encryption Key and Data Supplier Encryption Key for use by the encryption application.
Operations
public PPSGenerateKey( )
Parameter None
Description This method is the default constructor
Returns None
Exceptions None
generateKey
public byte[] generateKey( )
Parameter None
Description This method generates a 16-byte AES key using Sun JCE's key generation algorithm.
Returns The 16-byte AES key that is generated
Exceptions PPSException—If exceptions are encountered during execution, these exceptions are encaPPSulated in a custom exception class called “PPSException” and thrown back to the method/application invoking this method.
Class PPSDeriveKey:
Operations
public PPSDeriveKey ( )
Parameter None
Description This method is the default constructor
Returns None
Exceptions None
public byte[] deriveEncryptionKey(String seed)
Parameter seed—Seed from which the key has to be derived
Description This method invokes keyDerivationAlgorithm( ) method to derive a key from the seed.
Returns The derived key
Exceptions PPSException—If exceptions encountered during execution, these exceptions are encaPPSulated in a custom exception class called “PPSException” and thrown back to the method/application invoking this method.
public byte[] keyDerivationAlgorithm (String seed)
Parameter seed—Seed from which the key has to be derived
Description This method implements the key derivation logic. The key derivation algorithm used here is non-standard version of SHA 1 algorithm.
Returns The derived key
Exceptions PPSException—If exceptions encountered during execution, these exceptions are encaPPSulated in a custom exception class called “PPSException” and thrown back to the method/application invoking this method.
Class PPSSecure Encryption Key:
Operations
public PPSSecureEncryptionKey( )
Parameter None
Description This method is the default constructor
Returns None
Exceptions None
public String secureKey(byte[] encryption Key)
Parameter encryption Key—The encryption key that has to be encrypted and stored securely
Description This method does the following:
   a) Generates a random seed by invoking Java's random number generator
   b) Invokes the deriveEncryptionKey( ) method of the PPSDeriveKey class by passing the seed generated as input. This method generates a key out of the seed passed and returns the key
   c) Invokes the encryptData( ) method of the PPSUtils class by passing the encryption Key obtained as input to the secureKey method and the key generated in step 2 above. The encryptData( ) method returns the encrypted key
   d) Base-64 encodes the encrypted key obtained from the encryptData( ) method
   e) Concatenates the Base-64 encoded encrypted key and the seed using ‘|’ as delimiter
Returns Encrypted key concatenated with seed
Exceptions PPSException—If exceptions encountered during execution, these exceptions are encaPPSulated in a custom exception class called “PPSException” and thrown back to the method/application invoking this method.
public void decryptKey(PPSConfig objPPSConfig)
Parameter objPPSConfig—The PPSConfig object which contains the encryption key file names
Description This method does the following:
   4. Gets the names of the Longitudinal Key file and the Data Supplier Encryption key file from the PPSConfig object
   5. Reads the keys from the key files
   6. Performs the following steps on both the keys:
      a) Base-64 decodes the input read from the key file. The Base-64 decoded value contains encrypted key, seed and hash constituents separated using appropriate delimiters
      b) Invokes the checklntegrityvalue( ) method of the PPSUtils class by passing the hash value and encrypted key concatenated with seed as inputs. Throws an exception if checklntegrityvalue( ) returns a false
      c) Extracts the encrypted key, seed and hash constituents of the input using appropriate delimiters
      d) The encrypted key extracted in Step 3c above is Base-64 encoded. The key is Base-64 decoded
      e) Invokes the deriveEncryptionKey( ) method of the PPSDeriveKey class by passing the seed. This method generates a key out of the seed passed and returns the key
      f) Invokes the decryptData( ) method of the PPSUtils class by passing the decoded encrypted key obtained in step 3d above and the key generated in step 3e above. The decryptData( ) method returns the decrypted key
   7. Loads the decrypted keys into PPSConfig object
Returns None
Exceptions PPSException—If exceptions encountered during execution, these exceptions are encaPPSulated in a custom exception class called “PPSException” and thrown back to the method/application invoking this method.
Class PPSKeyGenerator:
Operations
public static void main( String args[])
Parameter args[]—Array of command line arguments. The name of the file where the generated key has to be stored is passed as a command line argument
Description This method does the following:
   1. Invokes the generateKey( ) method of the PPSGenerateKey class
   2. On successful generation of the key, invokes the secureKey( ) method of the PPSSecureEncryptionKey class to encrypt the generated key
   3. Invokes the getlntegrityvalue( ) method of the PPSUtils class to calculate the integrity value of the return string from the secureKey( ) method invoked in step 2 above.
   4. Concatenates the return string from secure key method and the integrity value calculated in step 3 above using˜as the delimiter
   5. Base-64 encodes the concatenated string generated in step 4 above
   6. Writes the concatenated value into the key file passed as command line argument
   7. Prints a message on the console indicating successful generation of key
   8. Exceptions caught during the process as key generation are logged as CRITICAL messages and the application terminates
Returns None
Exceptions None
Class PPSUtils:
Operations
public String getlntegrityValue (String input)
Parameter input—input string on which integrity value has to be calculated
Description This method computes the SHA1 hash of the input, base-64 encodes the hash and returns the encoded hash.
Returns SHA 1 hash that is computed
Exceptions PPSException—If exceptions are encountered during execution, these exceptions are encaPPSulated in a custom exception class called “PPSException” and thrown back to the method/application invoking this method.
public boolean checkIntegrityValue(String input, byte[] hash)
Parameter
   input—input string whose integrity has to be verified,
   hash—hash calculated on the input. This hash will be used for comparison
Description This method computes the SHA1 hash of the input and compares it against the hash passed as parameter. Returns true if the hashes match or false otherwise
Returns
   True—if hashes match indicating the input has passed the integrity check
   False—if hashes do not match indicating the input has failed the integrity check
Exceptions PPSException—If exceptions are encountered during execution, these exceptions are encaPPSulated in a custom exception class called “PPSException” and thrown back to the method/application invoking this method.
public int validateDate( String date)
Parameter Date—Date string that has to be validated
Description This method does the following:
   9. If the month is not valid (valid if between 1 and 12), 1 is returned
   10. If the Day is not valid (valid if between 1 and 31), 2 is returned. A check is also made to ensure that the day value does not exceed the maximum value for a month. This includes leap year checks for February
   11. If date validation is successful, 0 is returned
   Returns
   0—on successful date validation
   1—on failure of month validation
   2—on failure of day validation
Exceptions None
public byte[] encryptData( byte[], byte[])
Parameter
   byte[]—holds the AES Key that has to be used for encryption
   byte[]—holds the data that has be encrypted
Description This method initializes the cipher with the AES key given as input and Encrypts (single encrypt) the data with the key.
Returns byte[]—holds the encrypted data
Exceptions PPSException—If exceptions encountered during execution, these exceptions are encaPPSulated in a custom exception class called “PPSException” and thrown back to the method/application invoking this method.
public bytes[) decryptData( byte[], byte[])
Parameter
   byte[]—holds the AES Key that has to be used for decryption
   byte[]—holds the data that has be decrypted
Description This method initializes the cipher with the AES key given as input and Decrypts (single) the data with the key.
Returns byte[]—holds the Decrypted data
Exceptions PPSException—If exceptions encountered during execution, these exceptions are encaPPSulated in a custom exception class called “PPSException” and thrown back to the method/application invoking this method.

### APPENDIX F

### Data Standardization Module Class Functions and Methods

ClassPPSStandardize:
Operations
public PPSStandardize getlnstance( )
Parameter None
Description This method does the following:
   12. Checks if an instance of PPSStandardize class already exists
   13. If an instance does not exist
      f) Checks for presence of first name standardization file. If file is not present in the specified path, throws an exception and returns
      g) Creates an instance of PPSStandardize class
   14. If an instance exists, return the instance
Returns None
Exceptions None
public void standardizeAttributes( PPSVariabless objPPSVariabless)
Parameter objPPSVariabless—PPSVariabless object containing the name of the first name standardization file read from the configuration file
Description This method does the following:
   15. If the Patient Date of Birth attribute in PPSVariables object is not null, calls the standardizeDOB( ) method
   16. If the Patient Gender attribute in PPS Variables object is not null and standardization of gender is desired, calls the standardizeGender( ) method
   17. If the Cardholder Id attribute in PPSVariables object is not null, calls the standardizeCardHolderldRecordNumber( ) method with an input of 1 (indicating cardholder id standardization)
   18. If the record number attribute in PPSVariables object is not null and standardization of record number is desired, calls the standardizeCardHolderldRecordNumber( ) method with an input of 2 (indicating record number standardization)
   19. If the Patient Zip attribute in PPSVariables object is not null, calls the standardizeZip( ) method
   20. If the Patient First Name attribute in PPSVariables object is not null, calls the standardizeName( ) method with an input of 1 (indicating first name standardization). For first name, the first name standardization file name is also passed
   21. If the Patient Last Name attribute in PPSVariables object is not null, calls the standardizeName( ) method with an input of 1 (indicating last name standardization)
   22. If the Data Supplier Patient Id attribute in PPSVariables object is not null, calls the standardizePatientld( ) method
   23. If the Patient Street Address attribute in PPSVariables object is not null, calls the standardizeStreetAddress( ) method
   24. The standardized values obtained are loaded into PPSVariabless object
Returns None
Exceptions PPSException—If exceptions are encountered during execution, these exceptions are encaPPSulated in a custom exception class called “PPSException” and thrown back to the method/application invoking this method.
private PPSStandardize ( )
Parameter None
Description This method is the default private constructor
Returns None
Exceptions None
private void standardizeDOB( )
Parameter None
Description This method does the following:
   25. If the patient date of birth format equals one of
      i. MMDDCCYV
      ii. MM/DD/CCYV
      iii. CCYV/MMIDD
      iv. converts the date of birth to format CCYVMMDD
   26. If the patient date of birth format is not anyone of the four formats mentioned above, logs a critical message and throws an appropriate PPSException
   27. If the patient date of birth attribute is missing (if the attribute is an empty string), Missing Patient Date of Birth count is incremented. This is done by invoking the incMissingDOBCt( ) method of the PPSAudit class. The patient Date of Birth attribute in PPS Variables is set to “B” and all other DOB validations are skipped
   28. If the year is not valid (valid if age less than or equal to 150 years or greater than or equal to −1 from the current date), 1 is be added to the invalid Patient DOB Year count by invoking inclnvalidDOBYCt( ) method of PPSAudit class and ‘I’ is written to the Patient Date of Birth attribute in PPS Variables object. All other Patient Date of Birth validation steps will be skipped.
   29. Calls validateDate( ) method of the PPSUtils class. If the month is not valid (indicated by a ‘1’ return from the method), 1 is be added to the invalid Patient DOB Month count by invoking inclnvalidDOBMCt( )method of PPSAudit class and ‘I’ is written to the Patient Date of Birth attribute in PPS Variables object. All other Patient Date of Birth validation steps will be skipped.
   30. If the Day is not valid (indicated by a ‘2’ return from the validateDate( ) method of PPSUtils class), 1 will be added to the invalid Patient DOB Day count by invoking the incinvalidDOBDCt( )method of PPSAudit class and ‘I’ is written to the Patient Date of Birth attribute in PPS Variables object. All other DOB validations steps will be skipped.
Returns None
Exceptions PPSException—If exceptions are encountered during execution, these exceptions are encaPPSulated in a custom exception class called “PPSException” and thrown back to the method/application invoking this method.
private void standardizeGender( )
Parameter None
Description This method does the following:
   31. If the Gender Format Indicator given in PPSVariables equals “S”, gender is converted to format “A”
   32. If the patient gender format indicator is not a valid one, PPSException is thrown
   33. If the patient gender attribute is missing (if the attribute is an empty string), Missing Patient Gender count is incremented. This is done by invoking the incMissingGenderCt( ) method of the PPSAudit class. The patient Gender attribute in PPSVariables is set to “B” and all other gender validations are skipped
   34. If the patient gender attribute is not valid (valid if 1,2, 3), Invalid Patient Gender count is incremented. This is done by invoking the incinvalidGenderCt( ) method of the PPSAudit class. The patient Gender attribute in PPS Variables is set to “I”.
Returns None
Exceptions PPSException—If exceptions are encountered during execution, these exceptions are encaPPSulated in a custom exception class called “PPSException” and thrown back to the method/application invoking this method.
private void standardizeCardholderldRecordNumber(int option)
Parameter option ! Value indicating whether cardholder id or record number standardization should be performed
Description This method does the following:
   35. The integer input passed to the method indicates Cardholder Id or record number standardization. Input value of 1 indicates cardholder id and 2 indicates record number
   36. This method left justifies the data contents
   37. Leading zeroes and spaces are removed. Remaining contents left justified
   38. All special symbols (-*&I\\][{};:'.,<″) are removed. Remaining contents left justified to fill gaps
   39. Remaining right most bytes space filled
   40. If the input attribute is missing (all blanks, spaces, zeros), 1 will be added to the Missing Cardholder Id or Missing Record Number count depending on whether the standardization applies to cardholder id or record number and ‘B’ is written to the Cardholder Id or Record Number attribute. All other validations will be skipped
   41. If the input attribute is invalid (all one character or one number, e.g. 11111111 or aaaaaaaa), 1 will be added to the Invalid Cardholder Id count or Invalid Record Number count and ‘I’ is written to the Cardholder Id or Record Number attribute.
   42. All contents will be standardized to all upper case to make sure that the encrypted values are same for comparison.
Returns None
Exceptions PPSException—If exceptions are encountered during execution, these exceptions are encaPPSulated in a custom exception class called “PPSException” and thrown back to the method/application invoking this method.
private void standardizeZip ( )
Parameter None
Description This method does the following:
   43. If the Patient Zip Code is missing (all blanks, zeros), 1 is added to the Missing Patient Zip Code count by invoking incMissingZipCt( ) method of PPSAudit class and ‘B’ is written to the Patient Zip Code attribute contained in PPSVariables object. All other Patient Zip Code validation is skipped
   44. If the Patient Zip Code is invalid, 1 is added to the Invalid Patient Zip Code count by invoking the incinvalidZipCt( )method of PPSAudit class and ‘I’ is written to the Patient Zip Code attribute contained in PPS Variables object. All other Patient Zip Code validation will be skipped.
      A Patient Zip Code will be invalid if it contains
   All blanks
   All zeros
   Contains one or more special characters (_*&A\][{};:'.,<“)
Returns None
Exceptions PPSException—If exceptions are encountered during execution, these exceptions are encaPPSulated in a custom exception class called “PPSException” and thrown back to the method/application invoking this method.
private void standardizeName(int option, String firstNameStdFileName)
Parameter option ! Value indicating whether first name or last name standardization should be performed
   firstNameStdFileName ! Name of First Name Standardization file
Description This method does the following:
   45. The integer input passed to the method indicates first name or last name standardization. 1 indicate first name and 2 indicates last name standardization
   46. Data contents are left justified
   47. Leading zeros, blanks and spaces are removed. Remaining contents left justified
   48. All special symbols (_*&A\][{};:'.,<”) are removed. Remaining contents left justified to fill gaps
   49. Remaining right most bytes space filled
   50. Contents will be standardized to all upper case
   51. If the Patient First Name or Patient Last name is missing (all blanks, zeros, spaces), 1 is added to the Missing Patient First Name or Missing Last Name count and ‘B’ is written to the Patient First Name or Patient Last Name attribute. All other validations are skipped.
   52. If the Patient First Name or Patient Last Name is invalid (all numbers, all the same character), 1 is added to the Invalid Patient First Name or Invalid Patient Last Name count and ‘I’ is written to the Patient First Name or Patient Last Name attribute. All other Patient First Name or Patient Last Name validations are skipped.
   53. If standardization is performed for Patient First Name, the Patient First Name contents are compared to the Common First Name field in the First Name Standardization file. If a match is found, the Standard First Name contents are copied to the Patient First Name field
Returns None
Exceptions PPSException—If exceptions are encountered during execution, these exceptions are encaPPSulated in a custom exception class called “PPSException” and thrown back to the method/application invoking this method.
private void standardizePatientld( )
Parameter None
Description This method does the following:
   54. If the Data Supplier Patient Id Qualifier Indicator attribute present in PPSVariables class does not equal “01”, “02”, “03”, “04”, “05”, “99” or spaces then 1 is added to the Invalid Patient Id Qualifier count by invoking the incinvalidPatlDCt( ) method of PPSAudit class and ‘I’ is written to the Patient Id attribute. All other Patient Id validation steps are skipped. If no Data Supplier Patient Id Qualifier is provided in the input file, it should be assumed to contain “99” for the remainder of the processing
   55. Data contents are left justified
   56. Leading zeros, blanks and spaces are removed. Remaining contents left justified
   57. All special symbols (_*&A\][{};:'.,<″) will be removed. Remaining contents left justified to fill gaps
   58. Remaining right most bytes spaced filled
   59. Contents will be standardized to all upper case.
   60. If the Data Supplier Patient Id is missing (all blanks, zeros or spaces), 1 is added to the Missing Patient Id count by invoking the incMissingPatlDCt( )method of PPSAudit class and ‘B’ is written to the Patient Id attribute. All other Patient Id validations are skipped
   61. If the Data Supplier Patient ID is invalid (all the same numbers or all the same character), 1 is added to the Invalid Patient Id count by invoking the inclnvalidPatlDCt( ) method of PPSAudit class and ‘I’ is written to the Patient Id attribute. All other Patient ID validations are skipped
Returns None
Exceptions PPSException—If exceptions are encountered during execution, these exceptions are encaPPSulated in a custom exception class called “PPSException” and thrown back to the method/application invoking this method.
private void standardizeStreetAddress( )
Parameter None
Description This method does the following:
   62. Data contents are left justified
   63. Leading spaces are removed. Remaining contents left justified
   64. All special symbols (_*&A\][{};:'.,<″) are removed. Remaining contents left justified to fill gaps
   65. If the Patient Street Address is missing (all blanks, spaces, zeros), 1 will be added to the Missing Patient Street Address count by invoking the incMissingAddrCt( )method of PPSAudit class and ‘B’ is written to the Patient Street Address attribute. All other Patient Street Address validations are skipped
   66. If the Patient Street Address is invalid, 1 is added to the Invalid Patient Street Address count by invoking the inclnvalidAddrCT( )method of PPSAudit class and ‘I’ is written to the Patient Street Address attribute. Patient Street Address will be considered invalid if
      Street Address does not contain any numbers
      Contains more than 15 numeric digits in a row
   67. The Patient Street Address Attribute is read from left to right one digit at a time until a numeric value is found. The process continues reading until a non-numeric digit is found. The numeric value found from the starting and ending point will be written to the Patient Street Address attribute. The maximum number of digits to be accepted in a row is 15.
Returns None
Exceptions PPSException—If exceptions are encountered during execution, these exceptions are encaPPSulated in a custom exception class called “PPSException” and thrown back to the method/application invoking this method.

### APPENDIX G

### HIPAA Compliance Module Class Functions and Methods

Class PPSHipaa
Operations
public getlnstance( )
Parameter None
Description This method creates an instance of PPSHipaa and returns the handle to that instance.
Returns PPSHipaa
Exceptions PPSException—If exceptions encountered during execution, these exceptions are encaPPSulated in a custom exception class called “PPSException” and thrown back to the method/application invoking this method.
public init( )
Parameter None
Description This method does the following things
   68. Gets an instance of the PPSHippa by calling getlnstance( ) method
   69. Checks if the HIPAA zip code reference file exists, if not an exception is thrown.
   70. It checks the value of the “isHipaa” variable in the configuration file and populates a private member of the PPSHipaa class.
Returns None
Exceptions PPSException—If exceptions encountered during execution, these exceptions are encaPPSulated in a custom exception class called “PPSException” and thrown back to the method/application invoking this method.
public hipaaProcess (PPSVariable )
Parameter PPS Variable—is a handle to the record values, and the methods to get and set the record values.
Description This method
   71. Gets the “HIPAA zip code reference file” location from the PPSConfig object.
   72. It checks a private member of its class to determine if HIPAA need to be done for this Data Supplier. If it need not be performed for this Data Supplier, process exits from the method, otherwise following steps are performed
   73. Gets the standardized Patient DOB and Patient ZIP from the PPSVariable object.
   74. Standardize the Patient DOB and increment audit count if necessary (HIPAA Patient Year Over 88 Count)
   75. Standardize the Patient Zip and increment and set audit count if necessary (HIPAA Patient Zip Under 20K Count)
Returns None
Exceptions PPSException—If exceptions encountered during execution, these exceptions are encaPPSulated in a custom exception class called “PPSException” and thrown back to the method/application invoking this method.
private void PPSHipaa ( )
Parameter None
Description Constructor for this class
Returns None
private String hipaaDOB (String)
Parameter String ! holds the standardized Date of Birth of the patient.
Description This method converts the standardized patient DOB into a HIPAA compliant value as per the HIPAA rules that needs to be applied. If necessary it will also increment HIPAA Patient Year Over 88 Count.
   The following are the HIPAA compliance rules applied on DOB
   76. For the HIPAA Patient Date of Birth attribute “01” is written to the Day and Month components of the date
   77. For the HIPAA Patient Date of Birth Year component the year is copied from the Patient Date of Birth attribute. If the Patient Date of Birth attribute contains ‘B’ or ‘I’ move “1800” to the HIPAA patient Date of Birth year
   78. The year of birth calculates to an age of over 88 years old, move “0000” to the HIPAA Patient Date of Birth year component. Add 1 to the HIPAA Patient Year Over 88 counter within the Audit Encryption Counts table
Returns String—holds the HIPAA Date of Birth.
Exceptions PPSException—If exceptions encountered during execution, these exceptions are encaPPSulated in a custom exception class called “PPSException” and thrown back to the method/application invoking this method.
private String hipaaZIP (String1, String2)
Parameter
   String1 ! holds the standardized zip code
   String2 ! holds the location of the HIPAA zip code reference file.
Description This method converts the standardized patient Zip into a HIPAA compliant value as per HIPAA rules that needs to be applied. If necessary the method also increments HIPAA Patient Zip Under 20K Count.
   The following are the HIPAA rules applied on Zip
   79. If the Patient Zip Code is ‘I’ (invalid), move ‘I’ to the HIPAA Patient Zip Code
   80. If the Patient Zip Code is ‘B’ (missing), move ‘B’ to the HIPAA Patient Zip Code
   81. If the Patient Zip code is Valid (not missing or invalid)
      i. Move the Patient Zip Code to the HIPAA Patient Zip code
      ii. Move “00” to the right most two digits of the HIPAA Patient Zip Code
      iii. Compare the left most remaining three digits of the HIPAA Patient Zip Code to the HIPAA Zip Code Reference Table. If a match is found move “00000” to the HIPAA Patient Zip Code attribute
      iv. Add 1 to the HIPAA Under 20K Zip counter within the Audit Encryption Counts table
Returns String ! holds the HIPAA Zip code.
Exceptions PPSException—If exceptions encountered during execution, these exceptions are encaPPSulated in a custom exception class called “PPSException” and thrown back to the method/application invoking this method.

### APPENDIX H

### Encryption Module Class Functions and Methods

Class PPSEncrypt:
Operations
public PPSEncrypt getlnstance( )
Parameter None
Description This method creates an instance of PPSEncrypt and returns the handle to that instance.
Returns PPSEncrypt
Exceptions PPSException—If exceptions encountered during execution, these exceptions are encaPPSulated in a custom exception class called “PPSException” and thrown back to the method/application invoking this method.
public void encryptProcess( PPSVariable)
Parameter PPSVariable—is a handle to the record values, and the methods to get and set the record values.
Description This method performs the following operations
   82. Gets the Encryption keys from the PPSConfig object
   83. Gets the attribute values from the PPS Variable object
   84. The attribute values are then encrypted and encoded.
   85. The encoded values are set in the PPS Variable object
   86. The DataOutputRecordCount in the PPSAudit object is incremented
Returns None
Exceptions PPSException—If exceptions encountered during execution, these exceptions are encaPPSulated in a custom exception class called “PPSException” and thrown back to the method/application invoking this method.
public Cipher initCipher( byte[] )
Parameter byte[]—that holds the AES key
Description In this method, the algorithm, its key and the current mode (Encryption mode or Decryption mode) is set.
Returns A cipher object with the initialized parameters
Exceptions PPSException—If exceptions encountered during execution, these exceptions are encaPPSulated in a custom exception class called “PPSException” and thrown back to the method/application invoking this method.
protected byte[] singleEncrypt( byte[], byte[] )
Parameter
   byte[]—holds the key with which encryption needs to be done
   byte[]—holds the data that has to be encrypted
Description In this method, the data is single encrypted by making use of the specified key. The keys needs to be 16 bytes long, and the encryption is AES.
Returns byte[]—holds the encrypted value
Exceptions PPSException—If exceptions encountered during execution, these exceptions are encaPPSulated in a custom exception class called “PPSException” and thrown back to the method/application invoking this method.
private void PPSEncrypt( )
Parameter None
Description Constructor for this class.
Returns None
Exception None
private String encode( byte[] )
Parameter byte[]—The Double encrypted value is passed as input in a byte array.
Description This method does a BASE64Encoding on the value stored in the byte array.
Returns String—holds the encoded output.
Exceptions PPSException—If exceptions encountered during execution, these exceptions are encaPPSulated in a custom exception class called “PPSException” and thrown back to the method/application invoking this method.
private ArrayList encryptAttributes (Array List )
Parameter ArrayList—Holds the values of the list of parameters that need to be encrypted.
Description In this method, the attribute values in the ArrayList is double encrypted. The encrypted values are encoded and then made available in the output ArrayList object.
Returns ArrayList—holds the encrypted and encoded values of the input values Exceptions PPSException—If exceptions encountered during execution, these exceptions are encaPPSulated in a custom exception class called “PPSException” and thrown back to the method/application invoking this method.

Class PPSDecrypt. This class has methods that will be used during the Decryption of the AES Encryption key generated by the Key derivation module
Operations
public PPSDecrypt getlnstance( )
Parameter None
Description This method creates an instance of PPSDecrypt and returns the handle to that instance
Returns PPSDecrypt
Exceptions PPSException—If exceptions encountered during execution, these exceptions are encaPPSulated in a custom exception class called “PPSException” and thrown back to the method/application invoking this method.
public Cipher initCipher( byte[] )
Parameter byte[]—that holds the AES key
Description In this method, the algorithm, its key and the current mode (Encryption mode or Decryption mode) is set.
Returns A cipher object with the initialized parameters
Exceptions PPSException—If exceptions encountered during execution, these exceptions are encaPPSulated in a custom exception class called “PPSException” and thrown back to the method/application invoking this method.
protected byte[] singleDecrypt( byte[], byte[] )
Parameter
   byte[]—holds the key with which decryption needs to be done
   byte[]—holds the data that has to be decrypted
Description In this method, data is decrypted by making use of the cipher.
Returns byte[]—holds the decrypted value
Exceptions PPSException—If exceptions encountered during execution, these exceptions are encaPPSulated in a custom exception class called “PPSException” and thrown back to the method/application invoking this method.
private void PPSDecrypt( )
Parameter None
Description Constructor for this class
Returns None

### APPENDIX I

### Audit Module Class Functions and Methods

Class PPSAudit:
Operations
private PPSAudit ( )
Parameter None
Description The constructor will initialize all counters to zero.
Returns Not Applicable
Exceptions Not Applicable
private void init(PPSConfig)
Parameter PPSConfig—containing populated configuration values
Description This method performs the following operations to initialize the audit class
   87. Constructs the file name that contains the signature of the audit file (This file is also called secure audit file) from the audit file name.
   88. If the audit file name is of the format ‘filename.ext’ then the secure audit filename is created as ‘filename.AY -’
   89. Checks for existence of both non-secure audit file.
   90. Create a new secure and non-secure audit file only if both files do not exist.
   91. If the non-secure audit file is present and the secure audit file is not present throw a PPSexception with the message “Secure Audit file not found”
   92. If the non-secure audit file is not present and the secure audit file is present throw a PPSexception with the message “Audit file not found”.
   93. Open the non-secure and secure audit files and obtain a lock on these files to make sure it is not modified by any entity other than the encryption application.
   94. From the PPSConfig object store the list of attributes present in the configuration file in a HashMap with the key being the attribute names and the value is being “Yes” or “No”. Yes indicates the presence of the attribute in the configuration file and “No” indicates that the attribute is not present in the configuration file.
   95. Compute the HMAC of the audit file.
   96. Compare the HMAC obtained with that in the secure audit byte.
   97. If the HMAC matches then proceed the function will terminate successfully.
   98. If the HMAC does not match throw an PPSException with an error message “Secure Audit Integrity failed. Restore backup to continue”.
Returns void
Exceptions PPSException
public PPSAudit getlnstance( )
Parameter None
Description This static returns the single instance of the class. This class will call the constructor of PPSAudit in a synchronized fashion. This method will invoke the init method when a new instance of the class is created.
Returns PPSAudit
Exceptions None
public void update( )
   This audit function writes updates to the audit files as and when the buffered records are processed. ‘PPSProcessor’ class calls this function, to make sure that the audits are inline with the output record processed file.
Parameter None
Description
   99. Compute the HMAC of the audit file.
   100. Compare the HMAC obtained with that in the secure audit byte.
   101. If the HMAC matches then proceed to Step 4. If the HMAC does not match throw an PPSexception with the error message “Audit Integrity Check failed”.
   102. The output buffer will be constructed using the HashMap containing the attributes. Based on the value “Yes” output buffer will accordingly contain the audit counts for only that attributes. If the value is “No”, a “-” is written into that particular counter positions. For more information on the counter positions refer to the Requirements Document
   103. Once the output buffer is finalized the contents are written to the audit file.
   104. Once again a HMAC is computed using the vendor key and the output is written to the secure audit files.
Exceptions PPSException
public void finalize( )
Parameter None
Description
   105. Compute the HMAC of the audit file.
   106. Compare the HMAC obtained with that in the secure audit byte.
   107. If the HMAC matches then proceed to Step 4. If the HMAC does not match throw an PPSexception with the error message “Audit Integrity Check failed”.
   108. The output buffer will be constructed using the HashMap containing the attributes. Based on the value “Yes” output buffer will accordingly contain the audit counts for only that attributes. If the value is “No” a “-” is written into that particular counter positions. For more information on the counter positions refer to the Requirements Document
   109. Once the output buffer is finalized the contents are written to the audit file.
   110. Once again a HMAC is computed using the vendor key and the output is written to the secure audit files.
   111. File locks are released
   112. Secure and Non-secure audit files are closed
Exceptions PPSException
public void inclnputRecReleasedCt( )
Parameter None
Description Increments the input record released counter by 1.
public void incOutputRecReleasedCt( )
Parameter None
Description Increments the output record released counter by 1.
public void incMissingDOBCt( )
Parameter None
Description Increments the missing Date of Birth counter by 1.
public void inclnvalidDOBYCt( )
Parameter None
Description Increments the missing Date of Birth year counter by 1.
public void inclnvalidDOBMCt( )
Parameter None
Description Increments the missing Date of Birth month counter by 1.
public void inclnvalidDOBDCt( )
Parameter None
Description Increments the missing Date of Birth day counter by 1.
public void incMissingGenderCt( )
Parameter None
Description Increments the missing gender counter by 1.
public void inclnvalidGenderCt( )
Parameter None
Description Increments the invalid gender counter by 1.
public void IncMissingCHIDCt( )
Parameter None
Description Increments the missing cardholder ID counter by 1.
public void inclnvalidCHIDCt( )
Parameter None
Description Increments the invalid cardholder ID counter by 1.
public void incMissingRecNbrCt( )
Parameter None
Description Increments the missing record number counter by 1
public void inclnvalidRecNbrCt( )
Parameter None
Description Increments the invalid record number counter by 1
public void incMissingZipCt( )
Parameter None
Description Increments the missing patient zip counter by 1.
public void inclnvalidZipCt( )
Parameter None
Description Increments the invalid patient zip counter by 1.
public void incMissingFirstNameCt( )
Parameter None
Description Increments the missing Date of Birth day counter by 1.
Returns None
Exceptions None
public void inclnvalidFirstNameCt( )
Parameter None
Description Increments the invalid first name counter by 1.
public void incMissingLastNameCt( )
Parameter None
Description Increments the missing last name counter by 1
public void inclnvalidLastNameCt( )
Parameter None
Description Increments the invalid last name counter by 1
public void incMissingAddrCt( )
Parameter None
Description Increments the missing patient address counter by 1.
public void inclnvalidAddrCt( )
Parameter None
Description Increments the invalid patient address counter by 1.
public void incMissingPatIDCt( )
Parameter None
Description Increments the missing patient ID counter by 1.
public void incInvalidPatIDCt( )
Parameter None
Description Increments the invalid patient ID counter by 1.
public void incMissingPatIDQualCt( )
Parameter None
Description Increments the missing patient ID qualifier counter by 1.
public void inclnvalidPatIDQualCt( )
Parameter None
Description Increments the invalid patient ID qualifier counter by 1.
public void incHipaaYrOver88Ct( )
Parameter None
Description Increments HIPAA year over 88 years counter by 1
public void incHipaaZipUnder20KCt( )
Parameter None
Description Increments the HIPAA zip under 20000 counter by 1.

### APPENDIX J

### Reporting Module Class Functions and Methods

Class PPSReport:
Operations
private generateReport(String fromDate, String toDate char repOption, char repFormat, char reportingchoice)
Parameter
   String from Date
   String toDate
   Char repOption—Single/By day
   Char repFormat—File/Print
   Char reportingchoice—‘D’ for Data Supplier and ‘I’ for LDF
Description
   113. Calculate the number of audit records(lines) in the file.
   114. Create a list with the above number and populate the list with all the audit records. All audit contents are transferred to memory here.
   115. Initialize a new list with the size equal to the number of audit records.
   116. Loop until end of audit record size.
      h) Tokenize each record
      i) Store the only audit dates in a new list.
   117. Perform a binary search on the list and find the closest match element for the fromDate(indexStart}.
   118. Perform a search and find the closest match element for the ToDate (indexEnd)
   119. Check the report option
   120. Print Common report information common to both report options
   121. If the report option is single
      j) Loop from indexStart to indexEnd
      k) Tokenize the audit record and calculate sum of all counts
         if all the audit counts encountered for a counter is ‘-’ print ‘-’ in report.
         Else assume value for audit record as zero and continue to calculate sum
      l) Print report based on print format
   122. If report option is by day
      m) Print information for each record
   123. End of method
Returns None
Exceptions PPSException
public PPSReport( )
Parameter None
Description The constructor will initialize all the class member variables
Returns None
Exceptions None
public void init(PPSConfig)
Parameter PPSConfig—containing populated configuration values
Description This method performs the following operations to initialize the report class
   124. Constructs the file name that contains the signature of the audit file (This file is also called secure audit file) from the audit file name.
   125. If the audit file name is of the format filename. ext then the secure audit filename is created as “filename.AY -”
   126. Checks for existence of both non-secure audit file.
   127. If the non-secure audit file does not exist create a new secure and nonsecure audit file.
   128. If the non-secure audit file is present and the secure audit file is not present throw a PPSexception with the message “audit file not found”
   129. Open the non-secure and secure audit files and obtain a lock on these files to make sure it is not modified by any entity other than the reporting application.
   130. Compute the HMAC of the audit file.
   131. Compare the HMAC obtained with that in the secure audit byte.
   132. If the HMAC matches then proceed the function will terminate successfully.
   133. If the HMAC does not match throw an PPSException with an error message “Secure Audit Integrity failed. Restore backup to continue”.
Returns None
Exceptions PPSException
public void generateDSReport(String from Date, String toDate, Char repOption, Char repFormat)
Parameter
   String from Date
   String toDate
   Char repOption
   Char repFormat
Description This methods invokes the private method generatereport with the
   From Date
   To date
   Report option
   Report Format
   ‘D’—option for generating report for data supplier
Exceptions PPSException
   Class PPSReportGenerator:
Operations
public static void main(args[])
Parameter args[]—array of command line arguments containing
   134. Report from
   135. Report To
   136. Report Option
   137. Report Format
   138. Report Output File Name
Description
   139. The application will check for valid dates (day, month and year) in the report from and report to field. If the dates are not supplied, the from date will assumed to be current date minus one month and the to date will assumed to be current date.
   140. If the report format is not mentioned the default will assumed to be a single aggregate
   141. If the reporting option is not mentioned the file format will be assumed to be default.
   142. The PPSreport class will be instantiated and initialized.
   143. The appropriate report method will be invoked and the report will be obtained.
   144. If any exceptions are encountered they will be logged as CRITICAL and the application will terminate.

### APPENDIX K

### Exception Handling Functions and Methods

Class PPSException:
Operations
public PPSException(String strExceptionMessage)
Parameter Holds the Error message that needs to be displayed
Description This method is a constructor which takes a string alone as input.
public PPSException(strexceptionMessage, exception Handle)
Parameter
   strexceptionMessage—Holds the Error message that needs to be displayed
   ExceptionHandle—Holds the Exception that was caught
Description This method is a constructor that takes a string and an exception handle as input.
public PPSException(exceptionHandle)
Parameter exceptionHandle—Holds the Exception that was caught
Description This method is a constructor that takes an exception handle alone as input.
public toString( )
Parameter None
Description This method is used to construct a string that would be printed whenever we try to print the exception object. It gives information regarding the nature of exception and the position where it occurred.

1. A computer-readable medium for preparing individual patient healthcare transaction data records contained in a data file for assembly in a longitudinally-linked database, the media comprising:
an acquire attributes module;
a standardization module;
an encryption key generation module; and
an encryption module;
wherein the acquire attributes module comprises methods that retrieve attributes from the data records contained in the data file, the attributes including selected patient-identifying attributes and/or non-identifying attributes,
wherein standardization module comprises methods that place the retrieved attributes in standard formats,
wherein the encryption key generation module comprises methods for generating a Data Supplier Longitudinal Encryption Key (K1) specific to a longitudinal database facility and Data Supplier Encryption Keys (K2) specific to a data supplier, and
wherein the encryption module comprises methods that doubly encrypt one or more retrieved patient-identifying attributes using keys K1 and K2.

2. The computer-readable medium of claim 1 wherein the standardization module comprises methods that place at least one of the following attributes: Patient Date of Birth; Patient Gender; Cardholder ID; Record Number; Patient Zip Code; Patient First Name; Patient Last Name; Data Supplier Patient ID; and Patient Street Address, in a standard format.

3. The computer-readable medium of claim 1 further comprising an HIPAA compliance module having methods that place selected patient-identifying attributes in an HIPPA compliant format.

4. The computer-readable medium of claim 3 wherein the HIPAA compliance module has methods that place at least one of Patient Date of Birth and Patient Zip Code attributes in a HIPPA compliant format.

5. The computer-readable medium of claim 1 wherein the encryption key generation module comprises methods for generating a Data Supplier Longitudinal Encryption Key (K1) specific to a longitudinal database facility and a Data Supplier Encryption Keys (K2) specific to data supplier.

6. The computer-readable medium of claim 1 wherein the encryption key generation module comprises a method for generating a key designed to encrypt keys K1 and K2.

7. The computer-readable medium of claim 1 wherein the encryption key generation module comprises a method that stores keys K1 and K2 in respective key files.

8. The computer-readable medium of claim 1 wherein the encryption module comprises methods for doubly-encrypting selected data attributes using keys K1 and K2 successively.

9. The computer-readable medium of claim 8 wherein the selected data attributes include at least one of the following attributes: Patient Date of Birth; Cardholder ID; Record Number; Patient Zip Code; Patient First Name; Patient Last Name; Data Supplier Patient ID; and Patient Street Address.

10. The computer-readable medium of claim 1 wherein encryption module comprises a method which encodes the encrypted data attributes.

11. The computer-readable medium of claim 1 further comprising at least one of auditing methods, logging methods and Exception/Error handling methods.

12. The computer-readable medium of claim 1 that is provided in a system for longitudinally-linking individual patient healthcare transaction data records obtained from multiple data suppliers, the system comprising:
at a data supplier location, a first component configured to:
acquire data records having patient-identifying attributes and non-identifying attributes; and
doubly encrypt the patient-identifying attributes in the data records with keys K1 and K2 generated by the key generation module;
at the LDF, a second component configured to:
receive doubly-encrypted data records from the multiple data suppliers;
partially decrypt the received data records so that the patient-identifying attributes retain the encryption by the first encryption key K1, and
a third component configured to:
assign an LDF identifier (ID) to the encrypted data records by matching attributes in the encrypted data records; and
link the encrypted data records ID by ID, whereby a longitudinal database is formed.
